(19) United States
(12) Patent Application Publication
(10) Pub. No.: US 2026/0371249 A1
(43) Pub. Date: Nov. 19, 2026

(54) Cell Re(Selection) or Ranking by Communication Device

(71) Applicant: Telefonaktiebolaget LM Ericsson (publ), Stockholm (SE)

(72) Inventors: Andreas Höglund, Solna (SE); Santhan Thangarasa, Vällingby (SE); Muhammad Ali Kazmi, Reston, VA (US); Olof Liberg, Enskede (SE); Mohammad Mozaffari, Fremont, CA (US); Kazuyoshi Uesaka, Kawasaki, Kanagawa (JP); Emre Yavuz, Stockholm (SE); Zhilan Xiong, Solna (SE); Chunhui Zhang, Stockholm (SE); Yanpeng Yang, Solna (SE)

(21) Appl. No.: 19/148,115

(22) PCT Filed: Jan. 17, 2024
(86) PCT No.: PCT/SE2024/050034

§ 371 Date: Jul. 15, 2025

Related U.S. Application Data
(60) Provisional application No. 63/439,563, filed on Jan. 17, 2023.

(51) Int. Cl. H04W 52/02; H04B 17/318; H04W 36/00

(52) U.S. Cl. CPC H04W 52/0235; H04B 17/328; H04W 36/0085

(57) ABSTRACT

A method performed by a communication device (12) is disclosed. The communication device (12) performs one or more measurements (M-1 . . . M-N) on a signal (24) from a cell (26). The communication device (12), based on one or more respective results of the one or more measurements (M-1 . . . M-N), evaluates a criterion (C) for selecting or reselecting on which cell (26) to camp or for ranking cells (26) in terms of how suitable the cells (26) are for camping on, wherein the criterion (C) depends on whether or not a wake-up receiver, WUR, (12W) is used to perform the one or more measurements (M-1 . . . M-N).

### TECHNICAL FIELD

The present application relates generally to a communication device, and relates more particularly to a communication device for cell (re)selection or ranking.

### BACKGROUND

A communication network transmits a paging message to a communication device in order to trigger the device to connect to the communication network, e.g., for receiving downlink user data. The paging message may for instance be transmitted over a downlink control channel, e.g., a Physical Downlink Control Channel (PDCCH). A communication device in this case must monitor and decode the downlink control channel in order to determine whether any paging message is intended for the device. Such monitoring and decoding, however, consumes device power and negatively impacts device battery life.

Reduced power consumption can be realized by the use of a so-called wake-up signal (WUS). A wake-up signal is a signal that indicates a communication device is to wake-up one or more receiver components, if needed, and monitor a downlink control channel, e.g., for any paging message intended for the device. A wake-up signal is designed so that it can be detected more quickly and/or without consuming as much power as compared to monitoring and decoding a downlink control channel. Exploiting a wake-up signal affords a communication device more frequent opportunities to operate in a low power mode, e.g., in between occasions in which the device is to monitor for the wake-up signal.

Yet additional power conservation can be realized by using a so-called wake-up receiver (WUR) to monitor for and receive the wake-up signal. A wake-up receiver is a receiver that is capable of receiving a wake-up signal and that is separate from another receiver (referred to as a main receiver) which is woken up upon the wake-up receiver receiving the wake-up signal. The wake-up receiver's circuitry is less complex and/or more power efficient than the main receiver. This may mean that the main receiver is capable of receiving some signals or channels that the wake-up receiver cannot. For example, the main receiver may be capable of receiving one or more other signals or channels (e.g., PDCCH) needed for connecting to the communication network, but the wake-up receiver may not be capable of receiving such signals or channels. Relieved of the need to receive the other signal(s) or channel(s), the wake-up receiver can be simplified and more power efficient than the main receiver. The wake-up receiver may for instance be dedicated for receiving the wake-up signal, and optionally, a synchronization signal. Or, even if not so dedicated, the wake-up receiver may be dedicated or tailored for receiving one or more signals or channels in a Radio Resource Control (RRC) idle state or an RRC inactive state, i.e., to the exclusion of one or more other signals or channels in an RRC connected state. In these and other cases, a communication device may be equipped with both a wake-up receiver and one or more other receivers (e.g., including a so-called main receiver) capable of receiving the other signal(s) or channel(s) that the wake-up receiver is not capable of receiving. The communication device can then power down one or more components of its one or more other receivers unless and until its wake-up receiver receives a wake-up signal.

Challenges nonetheless still exist in minimizing device power consumption and prolonging battery life. Indeed, even if a communication device can use a wake-up receiver to reduce how often the device has to monitor a downlink control channel, there are still limits on the power conservation benefits achievable with a wake-up receiver. A need thereby still remains for increasing power efficiency of communication devices equipped with a wake-up receiver.

### SUMMARY

Some embodiments herein accommodate a communication device using its wake-up receiver for measurements that would have heretofore required waking up the communication device's other receiver(s). Some embodiments for example accommodate the communication device usings its wakeup receiver for measurements based on which the communication device performs cell (re)selection, cell ranking, or other mobility procedures. One or more embodiments accommodate the wakeup receiver in this way by offsetting or otherwise adapting a measurement result, one or more values in cell (re)selection criterion(s), and/or one or more values in cell ranking criterion(s) to account for the wake-up receiver, e.g., to account for the lower receiver sensitivity and/or lower noise resistance of the communication device's wake-up receiver as compared to one or more other receivers of the communication device. By enabling the communication device to use its more power efficient wake-up receiver for purposes that would have heretofore required waking up the communication device's other, less power efficient receiver(s), some embodiments advantageously increase power efficiency and/or battery life of communication devices equipped with a wake-up receiver.

More particularly, embodiments herein include a method performed by a communication device. The method comprises performing one or more measurements on a signal from a cell. The method also comprises, based on one or more respective results of the one or more measurements, evaluating a criterion for selecting or reselecting on which cell to camp or for ranking cells in terms of how suitable the cells are for camping on, wherein the criterion depends on whether or not a wake-up receiver, WUR, is used to perform the one or more measurements.

In some embodiments, the criterion is for selecting or reselecting on which cell to camp. In some embodiments the criterion is fulfilled when, for each of the one or more measurements, a condition on a cell selection or reselection measurement value calculated from a result of the measurement is met. In some embodiments, for each of the one or more measurements, the respective cell selection or reselection measurement value depends on whether or not the WUR is used to perform the measurement. In some embodiments, for each of the one or more measurements, the respective cell selection or reselection measurement value is a function of the result of the measurement and a WUR-dependent parameter whose value depends on whether or not the WUR is used to perform the measurement. In some embodiments, for each of the one or more measurements, the WUR-dependent parameter of which the respective cell selection or reselection measurement value is a function is a minimum required level of the result of the measurement in the cell. In other embodiments, for each of the one or more measurements, the WUR-dependent parameter of which the respective cell selection or reselection measurement value is a function is an offset to a minimum required level of the result of the measurement in the cell. In yet other embodiments, for each of the one or more measurements, the WUR-dependent parameter of which the respective cell selection or reselection measurement value is a function is an offset to the result of the measurement in the cell. In some embodiments, for each of the one or more measurements, the WUR-dependent parameter of which the respective cell selection or reselection measurement value is a function is specific to a type of the communication device or a type of WUR used to perform the measurement. In some embodiments, the criterion is a criterion for selecting the cell as the cell to camp on, wherein the one or more measurements include a reference signal received power, RSRP, measurement and/or a reference signal received quality, RSRQ, measurement. In some embodiments, for the RSRP measurement, the WUR-dependent parameter is an offset Q_{rxlevminoffset}^{WUR} comprising an offset to a minimum required RSRP level Qᵣₓₗₑᵥₘᵢₙ in the cell if the WUR is used to perform the RSRP measurement. In other embodiments, for the RSRQ measurement, the WUR-dependent parameter is alternatively or additionally an offset Q_{qualminoffset}^{WUR} comprising an offset to a minimum required RSRQ level Q_{qualmin} in the cell if the WUR is used to perform the RSRQ measurement. In some embodiments, the criterion is a criterion for selecting the cell as the cell to camp on, wherein the one or more measurements include a reference signal received power, RSRP, measurement and/or a reference signal received quality, RSRQ, measurement. In some embodiments, for the RSRP measurement, the WUR-dependent parameter is a minimum required RSRP level Qᵣₓₗₑᵥₘᵢₙ^{WUR} in the cell if the WUR is used to perform the RSRP measurement. In other embodiments, for the RSRQ measurement, the WUR-dependent parameter is alternatively or additionally a minimum required RSRQ level Q_{qualmin}^{WUR} in the cell if the WUR is used to perform the RSRQ measurement. In some embodiments, the method further comprises receiving signaling indicating one or more respective values of one or more parameters. In some embodiments, a value of the WUR-dependent parameter is based on said one or more parameters. In some embodiments, said value of the WUR-dependent parameter is a function of a difference between a sensitivity of the WUR and a sensitivity of at least one other type of receiver. In some embodiments, said value of the WUR-dependent parameter is a function of said one or more parameters. In some embodiments, in said function, said one or more parameters scale and/or bias the difference between the sensitivity of the wake-up receiver and the sensitivity of the at least one other type of receiver.

In some embodiments, the criterion is for selecting or reselecting on which cell to camp. In some embodiments, the criterion is fulfilled when, for each of the one or more measurements, a condition on a cell selection or reselection measurement value calculated from a result of the measurement is met. In some embodiments, the condition depends on whether or not the WUR is used to perform the measurement. In some embodiments, for each of the one or more measurements, the condition on the cell selection or reselection measurement value calculated from the result of the measurement is met when the cell selection or reselection measurement value is greater than a WUR-dependent threshold. In some embodiments, the value of the WUR-dependent threshold depends on whether or not the WUR is used to perform the measurement. In some embodiments, the criterion is for reselecting on which cell to camp, wherein the cell is a serving cell of the communication device. In some embodiments, when the criterion is fulfilled, the communication device is to reselect on which cell to camp, wherein the one or more measurements include a reference signal received power, RSRP, measurement and/or a reference signal received quality, RSRQ, measurement. In some embodiments, for the RSRP measurement, the WUR-dependent threshold is a threshold S_{IntraSearchP}. In other embodiments, for the RSRQ measurement, the WUR-dependent threshold is alternatively or additionally a threshold S_{IntraSearchQ}. In some embodiments, the one or more measurements include a reference signal received power, RSRP, measurement and a reference signal received quality, RSRQ, measurement. In some embodiments, the criterion is for selecting or reselecting on which cell to camp, and the method further comprises selecting or reselecting on which cell to camp based on said evaluating of the criterion.

In some embodiments, the criterion is for ranking cells in terms of how suitable the cells are for camping on. In some embodiments, the one or more measurements comprise a reference signal received power, RSRP, measurement. In some embodiments, the criterion is a function of a WUR-dependent parameter whose value depends on whether or not the WUR is used to perform the RSRP measurement. In some embodiments, the WUR-dependent parameter is an offset to the result of the RSRP measurement.

In some embodiments, the criterion is for ranking cells in terms of how suitable the cells are for camping on, and the method further comprises ranking the cells in terms of how suitable the cells are for camping on based on said evaluating. In some embodiments, the criterion is for ranking cells in terms of how suitable the cells are for camping on, and the method further comprises selecting which cell to camp on according to the ranking of the cells. In some embodiments, the communication device is equipped with multiple types of receivers, including a WUR, and wherein the method further comprises using at least one of the multiple types of receivers to receive the signal from the cell.

Other embodiments herein include a communication device. The communication device is configured to perform one or more measurements on a signal from a cell. The communication device is also configured to, based on one or more respective results of the one or more measurements, evaluate a criterion for selecting or reselecting on which cell to camp or for ranking cells in terms of how suitable the cells are for camping on. In some embodiments, the criterion depends on whether or not a wake-up receiver, WUR, is used to perform the one or more measurements.

In some embodiments, the communication device is configured to perform the steps described above for a communication device.

In some embodiments, a computer program comprising instructions which, when executed by at least one processor of a communication device, causes the communication device to perform the steps described above for a communication device. In some embodiments, a carrier containing the computer program is one of an electronic signal, optical signal, radio signal, or computer readable storage medium.

Other embodiments herein include a communication device. The communication device comprises communication circuitry and processing circuitry. The processing circuitry is configured to perform one or more measurements on a signal from a cell. The processing circuitry is also configured to, based on one or more respective results of the one or more measurements, evaluate a criterion for selecting or reselecting on which cell to camp or for ranking cells in terms of how suitable the cells are for camping on, wherein the criterion depends on whether or not a wake-up receiver, WUR, is used to perform the one or more measurements.

In some embodiments, the processing circuitry is configured to perform the steps described above for a communication device.

### BRIEF DESCRIPTION OF THE DRAWINGS

FIG. 1 illustrates a block diagram of a communication network configured to provide communication service to a communication device according to certain embodiments.

FIG. 2 illustrates additional details of a communication network configured to provide communication service to a communication device according to certain embodiments.

FIG. 3 illustrates a block diagram of a communication device with criterion selecting or reselecting on which cell to camp according to certain embodiments.

FIGS. 4A-4C illustrate various embodiments of cell selection criterion of a communication device according to certain embodiments.

FIG. 5 illustrates the location of a WUS and the paging occasion to which it is associated according to certain embodiments.

FIG. 6 illustrates the variable length of a Wake-up Signal, WUS, depending on user equipment coverage.

FIG. 7 illustrates timeOffset-eDRX-Long in relation to timeOffsetDRX.

FIG. 8 is a logic flow diagram of a method performed by a communication device according to certain embodiments.

FIG. 9 is a logic flow diagram of a method performed by a communication device in accordance with other embodiments.

FIG. 10 is a logic flow diagram of a method performed by a communication device in accordance with other embodiments.

FIG. 11 is a logic flow diagram of a method performed by a network node in accordance with other embodiments.

FIG. 12 is a block diagram of a communication device configured for use in a communication network in accordance with particular embodiments.

FIG. 13 is a block diagram of a network node configured for use in a communication network in accordance with particular embodiments.

FIG. 14 shows an example of a communication system in accordance with some embodiments.

FIG. 15 is a block diagram of a host which may be an embodiment of the host of FIG. 14, in accordance with various aspects described herein.

FIG. 16 shows a communication diagram of a host communicating via a network node with a UE over a partially wireless connection in accordance with some embodiments.

### DETAILED DESCRIPTION

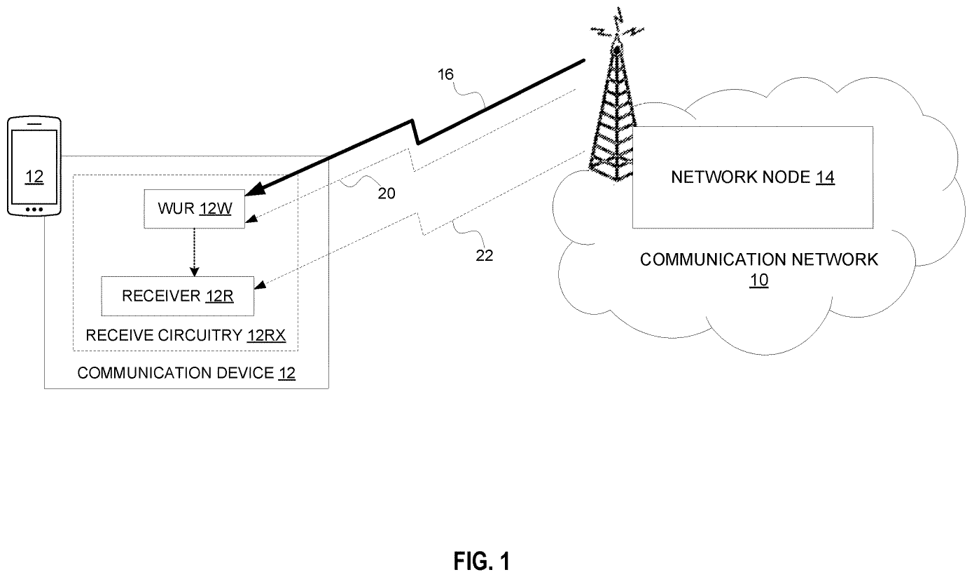

FIG. 1 shows a communication network 10 configured to provide communication service to a communication device 12 (e.g., a user equipment, UE), according to some embodiments. The communication network 10 may for example be a 5G network.

The communication device 12 as shown is equipped with receive circuitry 12RX for receiving one or more signals or channels from the communication network 10, e.g., from a network node 14 in the communication network 10 which may for example be a base station. One or more components of this receive circuitry 12RX are configurable to be put to sleep, e.g., in a sleep state. When put to sleep, the sleeping component(s) consume less power than when awake, e.g., such that the sleep state may also be referred to as a low power state. The sleeping component(s) may for instance be powered down so as to be inoperable unless and until the component(s) are awaken, e.g., by control circuitry which may be separate from or a part of the receive circuitry 12RX.

As one example, the receive circuitry 12RX may include or implement a receiver 12R. The receiver 12R is capable of receiving one or more signals or channels 22 needed for establishing a connection with the communication network 10, e.g., a Physical Downlink Control Channel (PDCCH), and/or for user data reception. The receiver 12R may for instance be capable of receiving a Physical Downlink Control Channel (PDCCH) and/or a Physical Downlink Shared Channel (PDSCH). The receiver 12R may therefore generally be usable for reception in a Radio Resource Control (RRC) connected mode. As such, the receiver 12R in some embodiments herein may be referred to as the communication device's ‘main receiver’.

In some embodiments, one or more components of the receiver 12R are configurable to be put to sleep. The communication device 12 may for instance put these component(s) to sleep unless and until those component(s) are needed for receiving a PDCCH, e.g., for checking for a paging message, and/or for receiving user data. That is, before the receiver 12R is able to receive certain signal(s) or channel(s), the asleep component(s) must be awaken.

The communication network 10 in this regard may transmit a wake-up signal (WUS) 20 to the communication device 12. The wake-up signal 20 triggers the communication device 12 to wake up one or more components of the receiver 12R from sleep.

In some embodiments as shown, the communication device's receive circuitry 12RX also includes or implements another receiver, referred to as a wake-up receiver (WUR) 12W, that is capable of receiving the wake-up signal 20. Although shown in FIG. 1 as being separate from the main receiver 12R, the WUR 12W may in some embodiments share one or more underlying hardware components of the receive circuitry 12RX with the main receiver 12R. The wake-up receiver 12W may not be capable of receiving one or more of the other one or more signals or channels 22, e.g., a PDCCH and/or PDSCH. The wake-up receiver 12W may generally be usable for reception in an RRC idle mode or an RRC inactive mode, as compared to the receiver 12R which may be usable for reception in an RRC connected mode. Regardless, in some embodiments, use of the wake-up receiver 12W enables the communication device 12 to put components of the receiver 12R to sleep, since the receiver 12R in this case is relieved of the need to detect the wake-up signal 20. Accordingly, in some embodiments, the wake-up receiver 12W is simplified and more power efficient than the main receiver 12R. In these and other embodiments, then, the communication device 12 is equipped with multiple types of receivers 12R, 12W, including a wake-up receiver 12W.

In operation in this case, when the communication device 12 does not need to receive the one or more signals or channels 22, such as when the communication device 12 is in an RRC idle or inactive mode, the communication device 12 operates the receiver 12R in a power-saving or sleep state, e.g., by powering down one or more components of the receiver 12R. During this time, though, the wake-up receiver 12W monitors for the wake-up signal 20. Reception of the wake-up signal 20 indicates to the communication device 12 that the receiver 12R needs to be awaken in order to monitor for the one or more signals or channels 22. That is, the wake-up signal 20 indicates to wake-up one or more components of the receiver 12R. Accordingly, responsive to detecting the wake-up signal 20, the wake-up receiver 12W wakes up the one or more components of the receiver 12R, whereupon the receiver 12R monitors for the one or more signals or channels 22.

Some embodiments herein accommodate the communication device 12 also using its wake-up receiver 12W for measurements that would have heretofore required waking up the communication device's receiver 12R. Some embodiments for example accommodate the communication device 12 usings its wakeup receiver 12W for measurements based on which the communication device 12 performs cell (re)selection, cell ranking, or other mobility procedures. One or more embodiments accommodate the wakeup receiver 12W in this way by offsetting or otherwise adapting measurement result(s), value(s) in cell (re)selection criterion(s), and/or value(s) in cell ranking criterion(s) to account for the wake-up receiver 12W, e.g., to account for the lower receiver sensitivity and/or lower noise resistance of the communication device's wake-up receiver 12W as compared to receiver 12R. By enabling the communication device 12 to use its more power efficient wake-up receiver 12W for purposes that would have heretofore required waking up the communication device's other, less power efficient receiver 12R, some embodiments advantageously increase power efficiency and/or battery life of the communication device 12.

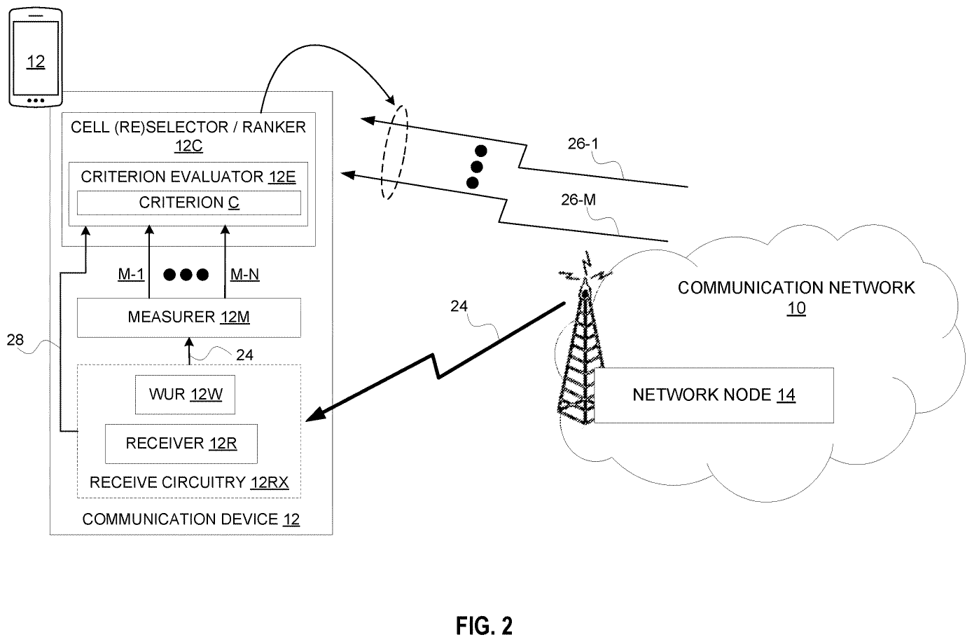

FIG. 2 illustrates additional details of some embodiments in this regard. As shown, the communication network 10 provides communication coverage to communication devices on cells 26-1 . . . 26-M (generally cell or cells 26), e.g., corresponding to respective carriers, respective cell identities, and/or respective cell-specific signals. At least some of the cells 26 may be provided over different coverage areas. Alternatively or additionally, at least some of the cells 26 may be provided on different carrier frequencies and/or be provided using different radio access technologies (RATs).

In this context, the communication device 12 is configured to select on which of the cells 26 to camp, e.g., as part of device mobility during a Radio Resource Control (RRC) idle or inactive state. Camping on a cell 26 herein refers to the communication device 12 monitoring one or more downlink signals or channels of the cell 26, at least discontinuously, e.g., from a state in which the communication device 12 has acquired system information and knows how to send a random access preamble on the random access channel to access the cell 26. In some embodiments, when the communication device 12 is camped on a cell, the communication device 12 has completed the cell (re)selection process, has chosen a cell, monitors system information, and (in most cases) monitors paging information, at least discontinuously in time. Camping therefore enables the communication device 12 to receive system information, initially access the communication network 10 on a control channel of the cell 26 on which it is camped, and receive a paging message and respond. When equipped with a wake-up receiver 12R, though, the communication device 12 may operate its (main) receiver 12R in a sleep state and monitor for a wake-up signal 26 as an indication to wake up the receiver 12R for monitoring the one or more downlink signals or channels.

The communication device 12 may select on which of the cells 26 to camp as part of initial cell selection, i.e., the communication device 12 is not camped on any cell upon the communication device 12 powering on and selects the initial cell on which the communication device 12 camps. Or, the communication device 12 may select on which of the cells 26 to camp as part of cell reselection, e.g., the communication device 12 is already camped on a cell 26 but one or more conditions prompt the communication device 12 to reselect on which cell to camp as part of searching for a more suitable cell. In these and other cases, the communication device 12 may rank cells 26 against each other, e.g., in terms of how suitable the cells 26 are for camping on.

FIG. 2 in this regard shows that the communication device 12 receives a signal 24 using its receive circuitry 12RX, i.e., using at least one of the multiple types of receivers 12R, 12W with which the communication device 12 is equipped. The signal 24 may for example be a reference signal (RS) or a synchronization signal (SS), such as a Primary SS (PSS) or a Secondary SS (SSS). The communication device 12 includes a measurer 12M that performs one or more measurements on this signal 24 as received by the receive circuitry 12RX, e.g., in the form of a Reference Signal Received Power (RSRP) measurement, an SS-RSRP measurement, a Reference Signal Received Quality (RSRQ) measurement, or an SS-RSRQ measurement. The measurer 12M provides the respective result(s) M-1 . . . M-N of the measurement(s) to a cell (re)selector/ranker 12C configured to select or reselect on which cell 26 to camp and/or to rank cells 26 in terms of how suitable the cells 26 are for camping on.

The cell (re)selector/ranker 12C performs such cell (re)selection and/or cell ranking based on a criterion C. As described more fully later, the criterion C may be a cell selection criterion on which the communication device 12 performs cell selection, a cell reselection criterion on which the communication device 12 performs cell reselection, or a cell ranking criterion on which the communication device 12 performs cell ranking. Regardless of the particular nature of the criterion C, though, the cell (re)selector/ranker 12C includes a criterion evaluator 12E configured to evaluate the criterion C for cell (re)selection or cell ranking. The criterion evaluator 12E evaluates the criterion C for cell (re)selection or cell ranking based on the result(s) M-1 . . . M-N of the measurement(s) provided by the measurer 12M. In fact, in some embodiments, the criterion C is specified as a function of the result(s) M-1 . . . M-N of the measurements.

Notably, the criterion evaluator 12E evaluates the criterion C for cell (re)selection or cell ranking also based on whether or not the WUR 12W was used to receive the signal 24, e.g., as indicated by a control signal 28 from the receive circuitry 12RX. The criterion evaluator 12E may for example selectively offset or otherwise adapt value(s) in the criterion C if the WUR 12W was used to receive the signal 24, e.g., to account for the lower receiver sensitivity and/or lower noise resistance of the WUR 12W as compared to receiver 12R. As such, the criterion C may thereby depend on whether or not the WUR 12W is used to perform the one or more measurements. In evaluating such a criterion C, the criterion evaluator 12E accommodates for the WUR 12W to be used for cell (re)selection or cell ranking. By enabling the communication device 12 to use its more power efficient WUR 12W for cell (re)selection or cell ranking, some embodiments advantageously increase power efficiency and/or battery life of the communication device 12.

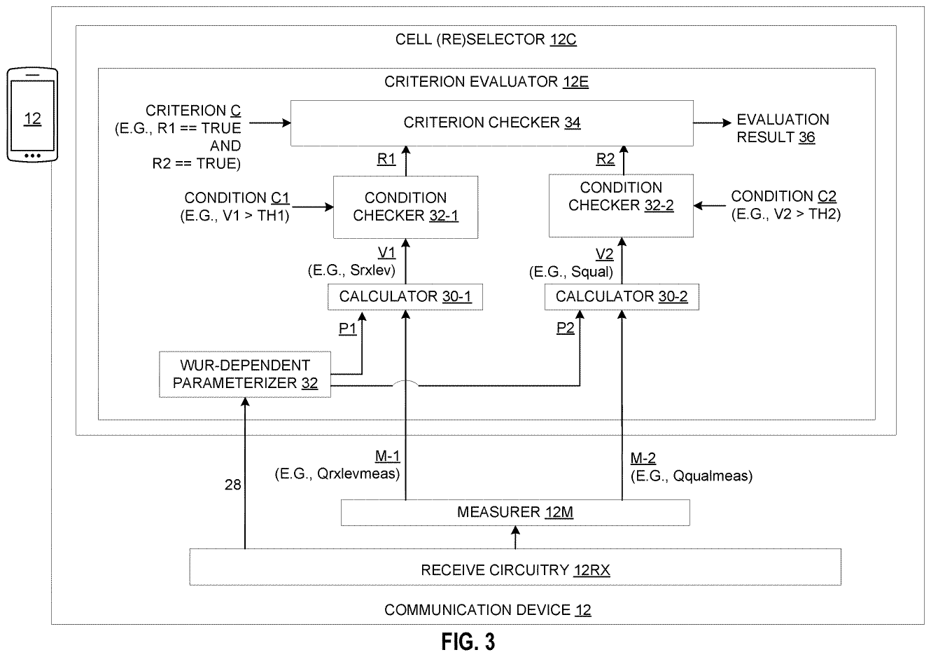

FIG. 3 illustrates an example where the criterion C is for selecting or reselecting on which cell 26 to camp. As shown, the measurer 12M provides the results M1, M2 of two measurements to the criterion evaluator 12E. In one embodiment, both measurement results M1 and M2 are results of measurements of the signal 24 received on a serving cell of the communication device 12. In these and other embodiments, measurement result M1 may be a measured cell receive level value, e.g., RSRP or SS-RSRP as represented by the variable Qᵣₓₗₑᵥₘₑₐₛ, whereas measurement result M2 may be a measured cell quality value, e.g., RSRQ or SS-RSRQ as represented by the variable Q_{qualmeas}.

For the first measurement, a first calculator 30-1 included in the criterion evaluator 12E calculates a cell (re)selection measurement value V1 from the measurement result M1 of that first measurement. Where the measurement result M1 is Qᵣₓₗₑᵥₘₑₐₛ, for example, the cell (re)selection measurement value V1 calculated from that measurement result M1 may be Sᵣₓₗₑᵥ. Similarly, for the second measurement, a second calculator 30-2 calculates a cell (re)selection measurement value V2 from the measurement result M2 of that second measurement. Where the measurement result M2 is Q_{qualmeas}, for example, the cell (re)selection measurement value V2 calculated from that measurement result M2 may be S_{qual}.

Notably, the criterion evaluator 12E further includes a WUR-dependent parameterizer 32. The WUR-dependent parameterizer 32 sets the values of WUR-dependent parameters P1 and P2 depending on whether or not the WUR 12W was used to receive the signal 24, e.g., as indicated by control signal 28 from the receive circuitry 12RX. In one embodiment, for example, the WUR-dependent parameterizer 32 sets the values of WUR-dependent parameters P1 and P2 to each be zero (0) if the WUR 12W was not used to receive the signal 24. Otherwise, if the WUR 12W was used to receive the signal 24, the WUR-dependent parameterizer 32 sets the values of the WUR-dependent parameters P1 and P2 to each be some non-zero value, e.g., to account for the lower receiver sensitivity and/or lower noise resistance of the WUR 12W as compared to receiver 12R.

The first calculator 30-1 accordingly calculates the cell (re)selection measurement value V1 from the measurement result M1 of the first measurement as well as WUR-dependent parameter P1. And the second calculator 30-2 calculates the cell (re)selection measurement value V2 from the measurement result M2 of the second measurement as well as WUR-dependent parameter P2. Calculation of the cell (re)selection measurement values V1, V2 thereby depend on and account for whether or not the WUR 12W was used to receive the signal 24.

Condition checker 32-1 thereafter checks whether or not a condition C1 on cell (re)selection measurement value V1 is met. In one embodiment, for example, the condition C1 is met if V1>TH1, e.g., where TH1 may be zero (0). Similarly, condition checker 32-2 checks whether or not a condition C2 on cell (re)selection measurement value V2 is met. In one embodiment, for example, the condition C2 is met if V2>TH2, e.g., where TH2 may also be zero (0). The condition checkers 32-1, 32-2 provide the respective results R1, R2 of their checks to criterion checker 34, e.g., with a result being TRUE if the condition is met and FALSE if the condition is not met.

Criterion checker 34 checks whether or not the criterion C is fulfilled, where the criterion C is specified as a function of the results R1 and R2. In one embodiment, for example, the criterion C is fulfilled when both of the conditions C1 and C2 are met, i.e., C is fulfilled if R1==TRUE and R2==TRUE. Regardless, criterion checker 34 then provides its evaluation result 36 to cell (re)selector 12C for use in cell (re)selection. The cell (re)selector 12C may for example select the cell from which the signal 24 was received, or at least consider the cell as a candidate for selection, if the criterion C is fulfilled.

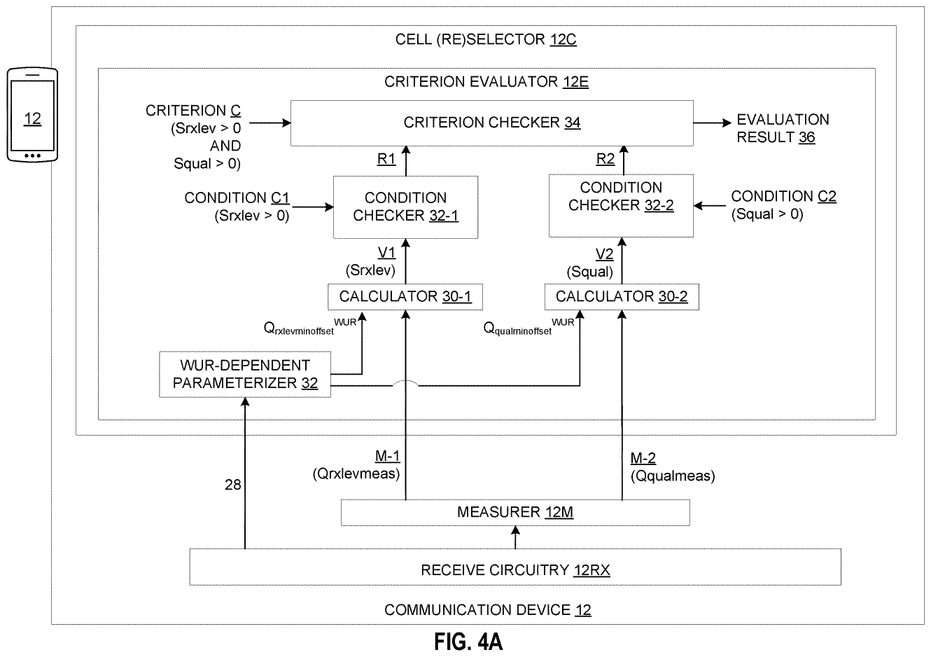

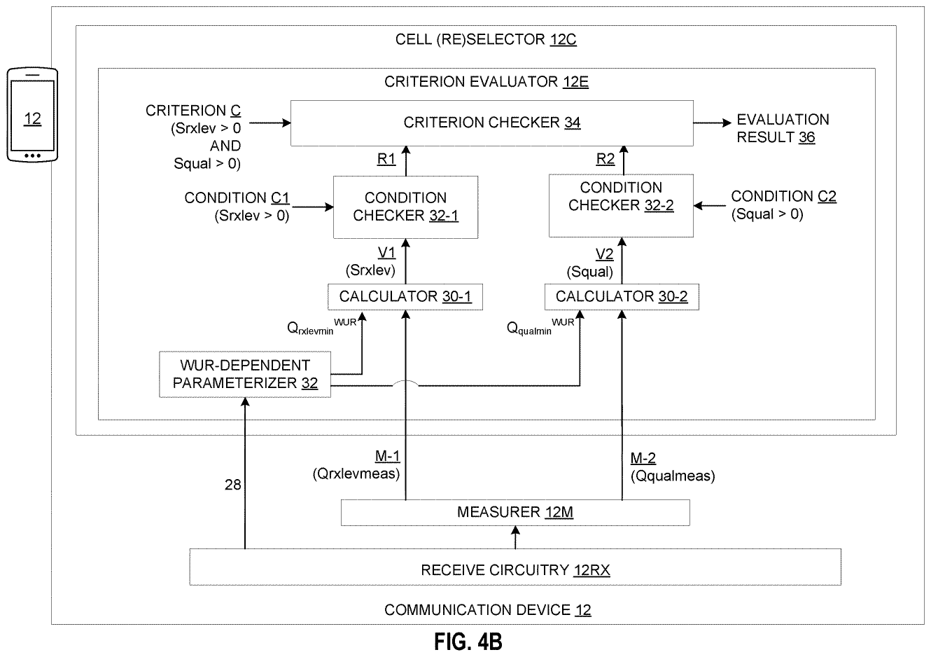

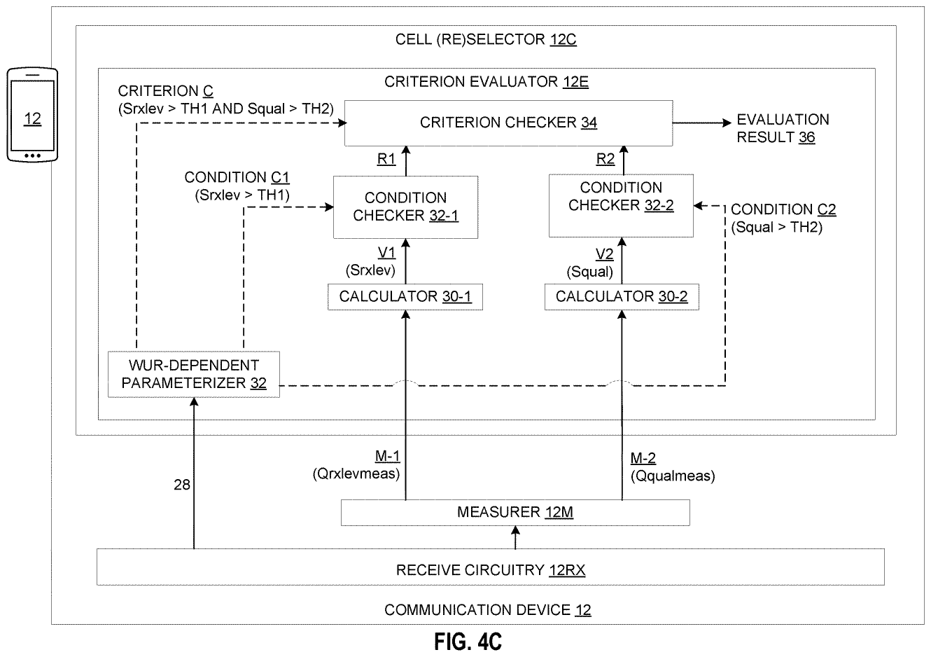

FIG. 4A shows a specific implementation as an example where the criterion C is a cell selection criterion S that is fulfilled when Srxlev>0 AND Squal>0. Specifically in this example, the first measurement result M-1 is the result Qᵣₓₗₑᵥₘₑₐₛ of a measured cell receive level value (RSRP), and the second measurement result M-2 is the result Q_{qualmeas} of a measured cell quality (RSRQ). WUR-dependent parameter P1 is an offset Q_{rxlevminoffset}^{WUR} to a minimum required level of Qᵣₓₗₑᵥₘₑₐₛ, and WUR-dependent parameter P2 is an offset Q_{qualminoffset}^{WUR} to a minimum required level of Q_{qualmeas}. The WUR-dependent parameters P1, P2 therefore take the form of WUR-specific compensation terms.

Calculator 30-1 calculates cell (re)selection measurement value V1 as Srxlev, and calculator 30-2 calculates cell (re)selection measurement value V2 as Squal, according to the below equations:

Srxlev=Qᵣₓₗₑᵥₘₑₐₛ−(Qᵣₓₗₑᵥₘᵢₙ+Q_{rxlevminoffset}+Q_{rxlevminoffset}^{WUR})−P_{compensation}−Qoffsetₜₑₘₚ

Squal=Q_{qualmeas}−(Q_{qualmin}+Q_{qualminoffset}+Q_{qualminoffset}^{WUR})−Qoffsetₜₑₘₚ

where:

| | |
|---|---|
| Srxlev | Cell selection RX level value (dB) |
| Squal | Cell selection quality value (dB) |
| Qoffsetₜₑₘₚ | Offset temporarily applied to a cell as specified in TS |
| | 38.331 (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the UE |
| | supports SUL frequency for this cell, Qᵣₓₗₑᵥₘᵢₙ is obtained |
| | from q-RxLevMinSUL, if present, in System Information |
| | Block (SIB)1, SIB2 and SIB4, additionally, if |
| | Q_{rxlevminoffsetcellSUL} is present in SIB3 and SIB4 for the |
| | concerned cell, this cell specific offset is added to the |
| | corresponding Qrxlevmin to achieve the required |
| | minimum RX level in the concerned cell; |
| | else Qᵣₓₗₑᵥₘᵢₙ is obtained from q-RxLevMin in SIB1, SIB2 |
| | and SIB4, additionally, if Q_{rxlevminoffsetcell} is present in |
| | SIB3 and SIB4 for the concerned cell, this cell specific |
| | offset is added to the corresponding Qrxlevmin to achieve |
| | the required minimum RX level in the concerned cell. |
| Q_{qualmin} | Minimum required quality level in the cell (dB). |
| | Additionally, if Q_{qualminoffsetcell} is signalled for the concerned |
| | cell, this cell specific offset is added to achieve the |
| | required minimum quality level in the concerned cell. |
| Q_{rxlevminoffset} | Offset to the signalled Qᵣₓₗₑᵥₘᵢₙ taken into account in the |
| | Srxlev evaluation as a result of a periodic search for a |
| | higher priority PLMN while camped normally in a |
| | VPLMN, as specified in TS 23.122. |
| Q_{qualminoffset} | Offset to the signalled Q_{qualmin} taken into account in the |
| | Squal evaluation as a result of a periodic search for a |
| | higher priority PLMN while camped normally in a |
| | VPLMN, as specified in TS 23.122. |
| P_{compensation} | For Frequency Region 1 (FR1), if the UE supports the |
| | additionalPmax in the NR-NS-PmaxList, if present, in |
| | SIB1, SIB2 and SIB4: |
| | max(P_{EMAX1} − P_{PowerClass}, 0) − (min(P_{EMAX2}, |
| | P_{PowerClass}) − min(P_{EMAX1}, P_{PowerClass})) (dB); |
| | else: |
| | max(P_{EMAX1} − P_{PowerClass}, 0) (dB) |
| | For FR2, P_{compensation} is set to 0. |
| | For Integrated Access Backhaul Mobile Termination |
| | (IAB-MT), P_{compensation} is set to 0. |
| P_{EMAX1}, P_{EMAX2} | Maximum TX power level of a UE may use when |
| | transmitting on the uplink in the cell (dBm) defined as |
| | P_{EMAX} in TS 38.101 If UE supports SUL frequency for |
| | this cell, P_{EMAX1} and P_{EMAX2} are obtained from the p-Max |
| | for SUL in SIB1 and NR-NS-PmaxList for SUL |
| | respectively in SIB1, SIB2 and SIB4 as specified in TS |
| | 38.331, else P_{EMAX1} and P_{EMAX2} are obtained from the |
| | p-Max and NR-NS-PmaxList respectively in SIB1, SIB2 |
| | and SIB4 for normal UL as specified in TS 38.331. |
| P_{PowerClass} | Maximum RF output power of the UE (dBm) according |
| | to the UE power class as defined in TS 38.101-1. |
| Q_{rxlevminoffset}^{WUR} | Offset to the signalled Qᵣₓₗₑᵥₘᵢₙ taken into account in the |
| | Srxlev evaluation if WUR is used for measurements. |
| Q_{qualminoffset}^{WUR} | Offset to the signalled Q_{qualmin} taken into account in the |
| | Squal evaluation if WUR is used for measurements. |

In some embodiments, the signalled values Q_{rxlevminoffset} and Q_{qualminoffset} are only applied when a cell is evaluated for cell selection as a result of a periodic search for a higher priority Public Land Mobile Network (PLMN) while camped normally in a Visited PLMN (TS 23.122). During this periodic search for higher priority PLMN, the communication device 12 may check the S criteria of a cell using parameter values stored from a different cell of this higher priority PLMN.

In any event, simplified for explanation, the purpose of the Srxlev value is that measured RSRP (signal strength) should be above a certain minimum level for the communication device 12 to select the cell, i.e. Qᵣₓₗₑᵥₘₑₐₛ−Qᵣₓₗₑᵥₘᵢₙ>0. If WUR 12W, and not the main receiver 12R, is used to measure Qᵣₓₗₑᵥₘₑₐₛ, the difference in sensitivity of the WUR 12W (expected to be worse) motivates a modification of the minimum level Qᵣₓₗₑᵥₘᵢₙ to have the same communication device behavior and cell (re)selection as if the main receiver 12R was used for the procedure. This is achieved by the new WUR-specific compensation term Q_{rxlevminoffset}^{WUR}, which is then only applied when WUR 12W is used for measurement of the signal 24 (or set to 0 when the main receiver 12R is used). A similar explanation holds for RSRQ (signal quality) and the use of Q_{qualminoffset}^{WUR}.

In one embodiment, the WUR-specific compensation terms are derived from the difference in receiver sensitivity between the main receiver (MR) 12R and the WUR 12W:

Q_{rxlevminoffset}^{WUR}=f(sensitivity_{MR},sensitivity_{WUR})

Q_{qualminoffset}^{WUR}=f(sensitivity_{MR},sensitivity_{WUR})

where f(.) can be a linear or non-linear function. Non-limiting examples of function f(.) are:

f(sensitivity_{MR},sensitivity_{WUR})=sensitivity_{MR}−sensitivity_{WUR}

f(sensitivity_{MR},sensitivity_{WUR})=k*(Sensitivity_{MR}−sensitivity_{WUR})

f(sensitivity_{MR},sensitivity_{WUR})=k*(Sensitivity_{MR}−sensitivity_{WUR})+r

where k and r are parameters for respectively scaling and biasing the value of the offset (compensation term) as a function of sensitivities of WUR 12W and main receiver 12R. That is, k scales the difference in receiver sensitivities whereas r biasing that difference. In one embodiment, the communication device 12 receives signaling from the communication network indicating the value of k and/or the value of r.

In one such embodiment, scaling factors such as k and r, are broadcasted as part of system information (SI) in the serving cell and communication devices camped in that cell apply those parameters based on the differences in sensitivities of their main receiver 12R and WUR 12W to compute the offsets, i.e., Q_{rxlevminoffset}^{WUR} and Q_{qualminoffset}^{WUR}.

Regardless of exactly how the WUR-specific compensation terms are derived from the difference in receiver sensitivity between the main receiver (MR) 12R and the WUR 12W, according to these embodiments, if the communication device 12 is using WUR 12W to perform measurements on the signal 24 received from a cell (e.g., to measure the SS-RSRP and SS-RSRQ level of the serving cell) and to evaluate the cell selection criterion S, a new WUR offset or compensation term is added to account for the difference in sensitivity of the WUR 12W and the main receiver 12R.

Alternatively or additionally, the WUR-specific compensation terms may be specific to the communication device 12. For example, these terms can be reported by the communication device 12 or determined by a type of the communication device 12, e.g., the offsets above may be determined by a WUR classification, or type, according to sensitivity requirements fulfilled. In one detailed example, if the type of the communication device 12 is WUR-type 1 and MR-type 1, then Q_{rxlevminoffset}^{WUR} and Q_{qualminoffset}^{WUR} are configured with the values corresponding to WUR-type 1 and MR-type 1; if the type of the communication device 12 is WUR-type 2 and MR-type 1, then Q_{rxlevminoffset}^{WUR} and Q_{qualminoffset}^{WUR} are configured with the values corresponding to WUR-type 2 and MR-type 1. As an example, WUR-type is defined with regard to its sensitivity, and MR-type is defined with regard to its sensitivity. In another detailed example, the sensitivity_MR and/or sensitivity_WUR in the equations above may be specific to the communication device 12 too.

In the example of FIG. 4A, then, for each of the measurements, the WUR-dependent parameter is an offset to a minimum required level of the result of that measurement. For the SS-RSRP measurement, for instance, the WUR-dependent parameter Q_{rxlevminoffset}^{WUR} is an offset to a minimum required level of the result Qᵣₓₗₑᵥₘₑₐₛ of that SS-RSRP measurement. And for the SS-RSRQ measurement, the WUR-dependent parameter Q_{qualminoffset}^{WUR} is an offset to a minimum required level of the result Qqualmeas of that SS-RSRP measurement.

FIG. 4B shows a slight variation of the example in FIG. 4A. In this case, for each of the measurements, the WUR-dependent parameter is a minimum required level of the result of that measurement (rather than being an offset to a minimum required level of the result of that measurement as in FIG. 4A). For the SS-RSRP measurement, as shown, then, the WUR-dependent parameter Qᵣₓₗₑᵥₘᵢₙ^{WUR} is a minimum required level of the result Qrxlevmeas of that SS-RSRP measurement. And for the SS-RSRQ measurement, the WUR-dependent parameter Q_{qualmin}^{WUR} is a minimum required level of the result Qqualmeas of that SS-RSRP measurement. According to these embodiments, the cell selection criterion S for the communication device 12 equipped with a WUR 12W is instead achieved by applying alternative and WUR-specific values for Qᵣₓₗₑᵥₘᵢₙ and Q_{qualmin}.

That is, if the communication device 12 uses WUR 12W for measuring the signal 24 from the cell, the cell selection criterion S is evaluated applying the following parameters:

| | |
|---|---|
| Qᵣₓₗₑᵥₘᵢₙ | UE applies WUR specific value Qᵣₓₗₑᵥₘᵢₙ_{_{—}}_{WUR} (dBm) |
| Q_{qualmin} | UE applies WUR specific value Q_{qualmin}_{_{—}}_{WUR} (dB) |

Similarly in this embodiment, the WUR-specific minimum level terms can be derived from the difference in receiver sensitivity between the main receiver (MR) 12R and the WUR 12W:

Q_{rxlevmin_WUR}=f(sensitivity_{MR},sensitivity_{WUR})

Q_{qualmin_WUR}=f(sensitivity_{MR},sensitivity_{WUR})

And scaling factors to the formula above may be broadcasted as part of system information in the serving cell and communication devices camped in that cell apply those parameters based on the differences in sensitivities of their MR 12R and WUR 12W to compute Q_{rxlevmin_WUR} and Q_{qualmin_WUR}.

Furthermore, the WUR-specific minimum level terms may be device-specific. For example, these terms can be reported by communication devices or determined by device types. In one detailed example, if the communication device's type is WUR-type 1, then Qᵣₓₗₑᵥₘᵢₙ^{WUR} and Q_{qualmin}^{WUR} are configured with the values corresponding to WUR-type 1; if the communication device's type is WUR-type 2, then Qᵣₓₗₑᵥₘᵢₙ^{WUR} and Q_{qualmin}^{WUR} are configures with the values corresponding to WUR-type 2. In another example, the sensitivity_MR and/or sensitivity_WUR in the equations above may be device-specific too.

In another embodiment, if the communication device 12 is using WUR 12W to measure the SS-RSRP and SS-RSRQ level of the serving cell and evaluate the cell selection criterion S, a new WUR-specific variant of the cell selection criterion S is applied:

The cell selection criterion S is fulfilled when:

Srxlev>0 AND Squal>0

where:

Srxlev=Qᵣₓₗₑᵥₘₑₐₛ−(Qᵣₓₗₑᵥₘᵢₙ+Q_{rxlevminoffset})−P_{compensation}−Qoffsetₜₑₘₚ

Squal=Q_{qualmeas}−(Q_{qualmin}+Q_{qualminoffset})−QOffsetₜₑₘₚ

where:

| | |
|---|---|
| Srxlev | Cell selection RX level value (dB) |
| Squal | Cell selection quality value (dB) |
| Qoffsetₜₑₘₚ | Offset temporarily applied to a cell as specified in TS |
| | 38.331 (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the UE |
| | supports SUL frequency for this cell, Qᵣₓₗₑᵥₘᵢₙ is obtained |
| | from q-RxLevMinSUL, if present, in SIB1, SIB2 and SIB4, |
| | additionally, if Q_{rxlevminoffsetcellSUL} is present in SIB3 and |
| | SIB4 for the concerned cell, this cell specific offset is |
| | added to the corresponding Qrxlevmin to achieve the |
| | required minimum RX level in the concerned cell; |
| | else Qᵣₓₗₑᵥₘᵢₙ is obtained from q-RxLevMin in SIB1, SIB2 |
| | and SIB4, additionally, if Q_{rxlevminoffsetcell} is present in SIB3 |
| | and SIB4 for the concerned cell, this cell specific offset is |
| | added to the corresponding Qrxlevmin to achieve the |
| | required minimum RX level in the concerned cell. |
| Q_{qualmin} | Minimum required quality level in the cell (dB). |
| | Additionally, if Q_{qualminoffsetcell} is signalled for the concerned |
| | cell, this cell specific offset is added to achieve the |
| | required minimum quality level in the concerned cell. |
| Q_{rxlevminoffset} | Offset to the signalled Qᵣₓₗₑᵥₘᵢₙ taken into account in the |
| | Srxlev evaluation as a result of a periodic search for a |
| | higher priority PLMN while camped normally in a |
| | VPLMN, as specified in TS 23.122. |
| Q_{qualminoffset} | Offset to the signalled Q_{qualmin} taken into account in the |
| | Squal evaluation as a result of a periodic search for a |
| | higher priority PLMN while camped normally in a |
| | VPLMN, as specified in TS 23.122. |
| P_{compensation} | For FR1, if the UE supports the additionalPmax in the |
| | NR-NS-PmaxList, if present, in SIB1, SIB2 and SIB4: |
| | max(P_{EMAX1} − P_{PowerClass}, 0) − (min(P_{EMAX2}, P_{PowerClass}) − |
| | min(P_{EMAX1}, P_{PowerClass})) (dB); |
| | else: |
| | max(P_{EMAX1} − P_{PowerClass}, 0) (dB) |
| | For FR2, P_{compensation} is set to 0. |
| | For IAB-MT, P_{compensation} is set to 0. |
| P_{EMAX1}, | Maximum TX power level of a UE may use when |
| P_{EMAX2} | transmitting on the uplink in the cell (dBm) defined as |
| | P_{EMAX} in TS 38.101. If UE supports SUL frequency for |
| | this cell, P_{EMAX1} and P_{EMAX2} are obtained from the p-Max |
| | for SUL in SIB1 and NR-NS-PmaxList for SUL |
| | respectively in SIB1, SIB2 and SIB4 as specified in TS |
| | 38.331 [3], else P_{EMAX1} and P_{EMAX2} are obtained from the |
| | p-Max and NR-NS-PmaxList respectively in SIB1, SIB2 |
| | and SIB4 for normal UL as specified in TS 38.331. |
| P_{PowerClass} | Maximum RF output power of the UE (dBm) according to |
| | the UE power class as defined in TS 38.101-1. |

The signalled values Q_{rxlevminoffset} and Q_{qualminoffset} are only applied when a cell is evaluated for cell selection as a result of a periodic search for a higher priority PLMN while camped normally in a VPLMN (TS 23.122). During this periodic search for higher priority PLMN, the UE may check the S criteria of a cell using parameter values stored from a different cell of this higher priority PLMN.
If the UE is using WUR for mobility measurement:

Srxlev=Qᵣₓₗₑᵥₘₑₐₛ^{WUR}−(Qᵣₓₗₑᵥₘᵢₙ^{WUR}+Q_{rxlevminoffset})−P_{compensation}−Qoffsetₜₑₘₚ

Squal=Q_{qualmeas}^{WUR}−(Q_{qualmin}^{WUR}+Q_{qualminoffset})−Qoffsetₜₑₘₚ

### Where:

| | |
|---|---|
| Qᵣₓₗₑᵥₘₑₐₛ^{WUR} | Measured cell RX level value (RSRP) using WUR |
| Q_{qualmeas}^{WUR} | Measured cell quality value (RSRQ) using WUR |
| Qᵣₓₗₑᵥₘᵢₙ^{WUR} | Minimum required RX level in the cell (dBm) for WUR |
| | measurement. If the UE supports SUL frequency for this |
| | cell, Qᵣₓₗₑᵥₘᵢₙ is obtained from q-RxLevMinSUL, if present, |
| | in SIB1, SIB2 and SIB4, additionally, if Q_{rxlevminoffsetcellSUL} is |
| | present in SIB3 and SIB4 for the concerned cell, this cell |
| | specific offset is added to the corresponding Qrxlevmin to |
| | achieve the required minimum RX level in the concerned |
| | cell; |
| | else Qᵣₓₗₑᵥₘᵢₙ is obtained from q-RxLevMin in SIB1, SIB2 |
| | and SIB4, additionally, if Q_{rxlevminoffsetcell} is present in SIB3 |
| | and SIB4 for the concerned cell, this cell specific offset is |
| | added to the corresponding Qrxlevmin to achieve the |
| | required minimum RX level in the concerned cell. |
| Q_{qualmin}^{WUR} | Minimum required quality level in the cell (dB) for WUR |
| | measurement. Additionally, if Q_{qualminoffsetcell} is signalled |
| | for the concerned cell, this cell specific offset is added to |
| | achieve the required minimum quality level in the |
| | concerned cell. |

Note that Qᵣₓₗₑᵥₘₑₐₛ^{WUR}, Q_{qualmeas}^{WUR}, Qᵣₓₗₑᵥₘᵢₙ^{WUR}, and Q_{qualmin}^{WUR} may be WUR-UE-type specific (i.e. the detailed values are related to WUR-UE type.)

Although illustrated above with two conditions C1 and C2, in an alternative embodiment, the WUR-specific cell selection criterion S is only based on Srxlev, i.e., condition C1. If the received signal level strength Srxlev is sufficient and exceeds a configured threshold, then the cell is considered suitable for cell selection and cell reselection. The cell quality condition C2 based on Squal is not evaluated as part of the WUR-specific cell selection criterion. The reason for this is that the cell signal quality experienced by the WUR 12W is expected to be decoupled from the quality experienced by the main receiver 12R. This is in parts due to the different noise figure of the two receivers, but also due to expected or possible use of different parts of the carrier of the serving cell.

Other alternative formulations of Srxlev and Squal are possible for realizing the same compensation for use of the WUR 12W. As one alternative, for instance, for each of the one or more measurements, the WUR-dependent parameter based on which the respective cell (re)selection measurement value is calculated may be formulated instead as an offset to the result of the measurement in the cell, e.g., as an offset to Qᵣₓₗₑᵥₘₑₐₛ and as an offset to Q_{qualmeas}.

FIG. 4C illustrates still other embodiments. Here, rather than the cell (re)selection measurement values V1 and V2 being dependent on use of the WUR 12W, the conditions C1 and C2 and/or the criterion C are dependent on use of the WUR 12W. As shown, for example the WUR-dependent parameterizer 32 provides the condition checkers 32-1, 32-2 with thresholds TH1 and TH2 for conditions C1 and C2 that depend on whether or not the WUR 12W was used to receive the signal 24. In one example, if the WUR 12W was not used to receive the signal 24, the thresholds TH1 and TH2 are 0. But if the WUR 12W was used to receive the signal 24, the thresholds TH1 and TH2 are non-zero, e.g., with values that are functions of WUR sensitivity and main receiver sensitivity.

As one example implementation of this, the following cell selection criterion is updated if WUR 12W is used for measurements:

The cell selection criterion S is fulfilled when: Srxlev>0 AND Squal>0

Specifically, when WUR is used, the cell selection criterion is:

The cell selection criterion S is fulfilled when: Srxlev>A_wur AND Squal>B_wur, where A_wur and B_wur are functions of WUR sensitivity and main receiver sensitivity.

For example:

A_wur=F1(sensitivity_{MR},sensitivity_{WUR})

B_wur=F2(sensitivity_{MR},sensitivity_{WUR})

with F1 and F2 are functions taking receiver sensitivities and potentially other parameters as inputs.

Consider now another example specifically applicable for cell reselection criteria. if the communication device 12 is using WUR 12W to measure the SS-RSRP and SS-RSRQ levels of the serving cell and evaluate the cell re-selection criterion, a new WUR-specific variant of the cell re-selection criterion is applied to measurement rules for cell re-selection (TS 38.304 section 5.2.4.2). This can be WUR specific offsets introduced in the cell reselection criteria or WUR-specific thresholds such as S_{IntraSearchP} and/or S_{IntraSearchQ}.

In particular, WUR specific offsets may be introduced in the cell reselection criteria or WUR-specific thresholds S_{IntraSearchP} and/or S_{IntraSearchQ} may be introduced in the following rules used by the UE to limit needed measurements:
If the serving cell fulfils Srxlev>S_{IntraSearchP} and Squal>S_{IntraSearchQ}:
   If distance Thresh and referenceLocation are broadcasted in SIB19, and if UE supports location-based measurement initiation and has obtained its location information:
      If the distance between UE and the serving cell reference location referenceLocation is shorter than distanceThresh, the UE may not perform intra-frequency measurements;
      Else, the UE shall perform intra-frequency measurements;
   Else, the UE may not perform intra-frequency measurements;
Else, the UE shall perform intra-frequency measurements.
The UE shall apply the following rules for NR inter-frequencies and inter-RAT frequencies which are indicated in system information and for which the UE has priority:
   For a NR inter-frequency or inter-RAT frequency with a reselection priority higher than the reselection priority of the current NR frequency, the UE shall perform measurements of higher priority NR inter-frequency or inter-RAT frequencies according to TS 38.133.
   For a NR inter-frequency with an equal or lower reselection priority than the reselection priority of the current NR frequency and for inter-RAT frequency with lower reselection priority than the reselection priority of the current NR frequency:
      If the serving cell fulfils Srxlev>S_{nonIntraSearchP} and Squal>S_{nonIntraSearchQ}:
         If distanceThresh and referenceLocation are broadcasted in SIB19, and if UE supports location-based measurement initiation and has obtained its UE location information:
         If the distance between UE and the serving cell reference location referenceLocation is shorter than distanceThresh, the UE may choose not to perform measurements of NR inter-frequency cells of equal or lower priority, or inter-RAT frequency cells of lower priority;
         Else, the UE shall perform measurements of NR inter-frequency cells of equal or lower priority, or inter-RAT frequency cells of lower priority according to TS 38.133;
         Else, the UE may choose not to perform measurements of NR inter-frequency cells of equal or lower priority, or inter-RAT frequency cells of lower priority;
      Else, the UE shall perform measurements of NR inter-frequency cells of equal or lower priority, or inter-RAT frequency cells of lower priority according to TS 38.133.
If the UE supports relaxed measurement and relaxedMeasurement is present in SIB2, the UE may further relax the needed measurements9.

Other embodiments herein introduce similar updates and/or WUR-specific offsets for the cell ranking criterion (TS 38.304 section 5.2.4.6):

The cell-ranking criterion Rs for serving cell and Rn for neighbouring cells is defined by:

Rₛ=Q_{meas,s}+Q_{hyst}−Qoffsetₜₑₘₚ

Rₙ=Q_{meas,n}−Qoffset−Qoffsetₜₑₘₚ

where:

| Qₘₑₐₛ | RSRP measurement quantity used in cell reselections. |
|---|---|
| Qoffset | For intra-frequency: Equals to Qoffset_{s, n}, if Qoffset_{s, n} |
| | is valid, otherwise this equals to zero. |
| | For inter-frequency: Equals to Qoffset_{s, n} plus |
| | Qoffset_{frequency}, if Qoffset_{s, n} is valid, otherwise this |
| | equals to Qoffset_{frequency}. |
| Qoffsetₜₑₘₚ | Offset temporarily applied to a cell as specified in TS |
| | 38.331. |

The UE shall perform ranking of all cells that fulfil the cell selection criterion S.
The cells shall be ranked according to the R criteria specified above by deriving Q_{meas,n} and Q_{meas,s} and calculating the R values using averaged RSRP results.
If rangeToBestCell is not configured, the UE shall perform cell reselection to the highest ranked cell. If this cell is found to be not-suitable, the UE shall behave according to clause 5.2.4.4.
In all cases, the UE shall reselect the new cell, only if the following conditions are met:
the new cell is better than the serving cell according to the cell reselection criteria specified above during a time interval Treselection_{RAT};
more than 1 second has elapsed since the UE camped on the current serving cell.

According to one embodiments, then:

Rₛ=Q_{meas,s}+Q_{hyst}−Qoffsetₜₑₘₚ−Qoffset_{WUR}

Rₙ=Q_{meas,n}−Qoffset−Qoffsetₜₑₘₚ−Qoffset_{WUR}

where Qoffset_{WUR} is a WUR-specific offset used for calculating cell-ranking criterions for the serving cell (R_{S}) and neighbor cells (Rₙ).

Consider now other aspects herein, with the communication device 12 exemplified as a user equipment (UE).

### Serving Cell Evaluation Procedure Using WUR:

In one aspect of this embodiment, the UE measures the SS-RSRP and SS-RSRQ level of the serving cell using WUR and evaluates the cell selection criterion S for the serving cell at least once every M1*N1 discontinuous reception (DRX) cycle, and adapts one or more measurement procedures if the UE does not fulfill the S criterion for the serving cell. Parameters M1 and N1 are scaling factors. For example, M1 depends on a relation between the reference signal (RS) periodicity (Trs) (e.g., a Synchronization Signal Block (SSB)-based Radio Resource Management (RRM) Measurement Timing Configuration (SMTC) period) and DRX cycle length (Tdrx) e.g., M1=2 if Trs>20 ms and Tdrx≤640 ms, otherwise M1=1. M2 is UE receiver beam sweeping factor, which may further depend on one or more parameters such as DRX cycle length, UE power class, etc. Examples of the adapted measurement procedures include the following.

In a first example, the UE switches to the main receiver, which is different than the WUR, and uses it for performing the measurements until one or more conditions are met. Upon meeting the one or more conditions, the UE reverts to the WUR receiver for performing the measurements. Conditions can be pre-defined or configured by a network node. Examples of conditions are as follows, and note that conditions can be considered independently or in various possible combinations. The thresholds, such as maximum values for P, R, and Q can be broadcasted as part of system information in the serving cell.

One example condition may be that the UE has used the main receiver for performing measurements at least for a certain time period (T11) starting from the moment the UE switched from the WUR to the main receiver. The parameter, T11, can be pre-defined or configured by a network node.

Another example condition may be that the UE starts meeting cell selection criterion S for the same or another cell serving cell.

Yet another example condition may be that the UE starts using WUR instead of the main receiver. For instance, the condition may be that the serving cell measurement, e.g., based on the SS-RSRP level etc., is above a certain threshold consecutively for P times where P is [1, . . . , ∞]. Alternatively or additionally, the condition may be that the difference between serving cell measurements performed at different times, e.g., the difference between measurements performed at t and [t+(M1*N1 DRX cycle)], is less than a certain threshold consecutively for R times where R is [1, . . . , ∞]. Alternatively or additionally, the condition may be that the difference between serving cell measurements performed at a particular time and Q consecutive times is less than a certain threshold, where Q is [1, . . . , ∞], e.g., the difference between measurements performed at t and performed at [t+(Q*(M1*N1 DRX cycle))]. Alternatively or additionally, the condition may be that the UE fulfills the criteria for RRM relaxation as described in TS 38.304 V17.2.0 and TS 38.331 V17.2.0. Alternatively or additionally, the condition may be that, in non-terrestrial network (NTN), remaining time until cell switches, based on t_service, is more than a threshold.

A further example condition may be that, when using WUR, UE switches to the main receiver. For instance, the condition may be that the UE has used WUR for performing measurements at least for a certain time period starting from the moment the UE switched from the main receiver to WUR. The parameter T12 can be pre-defined or configured by a network node. Alternatively or additionally, the condition may be that the serving cell measurement, e.g., based on the SS-RSRP level etc., is below a certain threshold consecutively for V times where V is [1, . . . , ∞]. Alternatively or additionally, the condition may be that the difference between serving cell measurements performed at different times, e.g., the difference between measurements performed at t and [t+(M1*N1 DRX cycle)], is more than a certain threshold consecutively for Y times where Y is [1, . . . , ∞]. Alternatively or additionally, the condition may be that the difference between serving cell measurements performed at a particular time and Z consecutive times is less than a certain threshold, where Z is [1, . . . , ∞], e.g., the difference between measurements performed at t and performed at [t+(Z*(M1*N1 DRX cycle))]. Alternatively or additionally, the condition may be that, in NTN, remaining time until cell switches, based on t_service, becomes less than a threshold.

In a second example, the UE switches to the main receiver, and uses it for further evaluating the cell selection criterion S for the serving cell. If the UE does not meet the cell selection criterion S for the serving cell using the main receiver, only then the UE initiates the measurements of all neighbour cells indicated by the serving cell. Therefore, according to this rule, using the main receiver enables the UE to more accurately verify whether the cell selection criterion S for the serving cell is met or not. In one example, the UE continues using the main receiver for the subsequent tasks, e.g., measurements on neighbor cells if it still does not meet the S criteria. In another example, the UE may revert to the WUR receiver upon meeting one or more conditions. Examples of conditions are the same as described in the above example #1. In another example, if the UE meets the cell selection criteria then the UE continues using the main receiver.

In a third example, the UE continues using the WUR receiver even if it does not meet the S criteria for performing measurements of all neighbour cells indicated by the serving cell using the WUR receiver. But if the UE has not found any new suitable cell based on searches and measurements using the intra-frequency, inter-frequency, and inter-RAT information indicated in the system information during a certain time period (T12), only then it switches to the main receiver, and uses it for initiating the cell selection procedures for the selected Public Land Mobile Network (PLMN).

In a fourth example, the UE continues using the WUR receiver even if it does not meet the S criteria for performing measurements of all neighbour cells indicated by the serving cell using the WUR receiver. However, the UE adapts the time period (T13′) over which the searches and measurements using the intra-frequency, inter-frequency, and inter-RAT information indicated in the system information for identifying a suitable cell for cell reselection/selection, i.e., when the S criteria is not met. The adaptation of T13′ comprises modifying the time period compared to the time period (T13) used for identifying a suitable cell with the main receiver. In one example, the modification comprises the extended time period, e.g., T13′>T13. For example, T13=10 seconds, while T13′=12 seconds. If the UE cannot identify a suitable cell during T13′, then the UE initiates the cell selection procedures for the selected PLMN.

In any of the above examples, the UE may be required to meet different sets of measurement requirements depending on the type of receiver used by the UE for performing the serving cell measurement and evaluation of the serving cell. In one example, the measurement on the serving cell performed by the UE using the WUR is more relaxed (e.g., longer measurement period) compared to the same type of the measurement performed by the UE using the main receiver. Examples are shown in table 1 and table 2. In these examples, the UE when using the WUR (table 1) evaluates whether the serving cell meets the S criterion over a larger number of DRX cycles compared to the case when using the main receiver (table 2) to evaluate whether the serving cell meets the S criterion.

TABLE 1
An example of Nₛₑᵣᵥ when using WUR receiver
for serving cell evaluation

| | Scaling Factor (N1) | | | |
|---|---|---|---|---|
| DRX cycle | | FR2- | FR2- | Nₛₑᵣᵥ [number of |
| length [s] | FR1 | 1^{Note1} | 2 ^{Note2} | DRX cycles] |
| 0.32 | 1 | 8 | 12 | M1*N1*5 |
| 0.64 | | 5 | 8 | M1*N1*5 |
| 1.28 | | 4 | 6 | N1*3 |
| 2.56 | | 3 | 5 | N1*3 |

^{Note1}
Applies for UE supporting FR2-1 power class 2&3&4. For UE supporting FR2-1 power class 1 or 5, N1 = 8 for all DRX cycle length.
^{Note2}
Applies for UE supporting FR2-2 power class 2&3. For UE supporting FR2-2 power class 1, N1 = 12 for all DRX cycle length.

TABLE 2
An example of Nₛₑᵣᵥ when using main/legacy
receiver for serving cell evaluation

| | Scaling Factor (N1) | | | |
|---|---|---|---|---|
| DRX cycle | | FR2- | FR2- | Nₛₑᵣᵥ [number of |
| length [s] | FR1 | 1^{Note1} | 2 ^{Note2} | DRX cycles] |
| 0.32 | 1 | 8 | 12 | M1*N1*4 |
| 0.64 | | 5 | 8 | M1*N1*4 |
| 1.28 | | 4 | 6 | N1*2 |
| 2.56 | | 3 | 5 | N1*2 |

^{Note1}
Applies for UE supporting FR2-1 power class 2&3&4. For UE supporting FR2-1 power class 1 or 5, N1 = 8 for all DRX cycle length.
^{Note2}
Applies for UE supporting FR2-2 power class 2&3. For UE supporting FR2-2 power class 1, N1 = 12 for all DRX cycle length.

### Measurements of Intra-Frequency NR Cells:

The UE shall be able to evaluate whether a newly detectable intra-frequency cell meets the reselection criteria defined in TS 38.304 V17.2.0 within T_{detect,NR_Intra} when that Treselection=0.

The UE shall measure SS-RSRP and SS-RSRQ at least every T_{measure,NR_Intra} (see table 4.2.2.3-1, table 4.2.2.3-2 or table 4.2.2.3-3 in TS 38.304 V17.2.0) for intra-frequency cells that are identified and measured according to the measurement rules.

The UE shall filter SS-RSRP and SS-RSRQ measurements of each measured intra-frequency cell using at least 2 measurements. Within the set of measurements used for the filtering, at least two measurements shall be spaced by at least T_{measure,NR_Intra}/2.

In one embodiment, (not limited to the use of WUR but also applicable to eDRX), the requirement that RSRP and RSRQ measurements must be filtered over at least 2 measurements is relaxed. That is, to avoid unnecessary WURActive energy consumption, (or on time for the main receiver in case of eDRX). For example, by the following addition to TS 38.133 V17.7.0:
The UE shall filter the SS-RSRP and SS-RSRQ measurements of the serving cell using at least 2 measurements. Within the set of measurements used for the filtering, at least two measurements shall be spaced by, at least DRX cycle/2, or in case of WUR or eDRX spaced by at least 1.28 s.

### WUR Triggered S-Criteria Evaluation

In another embodiment, the WUR makes measurements on the wake-up signal (WUS) level of serving cell, or a WUR dedicated lower power reference signal (LP-RS) level of the serving cell. The WUR will only wake up the main receiver to evaluate the S-criteria for cell re-selection when the WUS level or reference signal level reaches a threshold or conditioned on other factors impacting the measurement reliability and/or measurement occasion availability. Such threshold may be configured by the network, for the other factors considered by UE to wake up the main receiver, the measurement accuracy, REFSENS difference of WUR and main receiver, UE moving speed, WUS signal time domain density, Reference signal time domain density, and power consumption ratio between the WUR and the main receiver are examples of the additional factors. Here, REFSENS is the reference sensitivity power level, e.g., the minimum mean power applied to each one of the UE antenna ports for all UE categories, at which the throughput shall meet or exceed the requirements for the specified reference measurement channel. For example, if the UE is moving at high speed, it is better to use the main receiver for measurement as it provides better accuracy and sufficient measurement occasions. In another example, if WUS or reference signal for WUR to measure is sparse in time domain, the WUR could decide to wake up the main receiver occasionally to improve the frequency of measurement occasions to match its moving speed. For another example, the main receiver can be woken up more frequently if the power consumption ratio between WUR and the main receiver is higher. For another example, the main receiver will be used for measurement if the WUR is moving out of its coverage area but still within main receiver coverage area. UE can decide to wake up the main receiver based on above mentioned conditions. Alternatively, the above conditions could be configured by network.

### Main Receiver Cell (Re)Selection

In one embodiment, the cell selection/cell suitability and reselection performed by the WUR needs to be confirmed by the main receiver as soon the main receiver becomes active. In one version, the main receiver performs cell selection/cell suitability determination measurements for confirming an earlier WUR cell selection/cell suitability determination after waking up to monitor a paging occasion to receive a page. The UE could be required to perform the cell selection/cell suitability determination using the main receiver before the paging occasion, after the paging occasion but before the random access transmission, or after completing the radio resource control (RRC) connection and returning to RRC inactive or idle state.

### Relaxed Measurements Using WUR

The UE can be configured with different types of relaxed measurement criterion (RMCs) for enabling UE power saving. Certain types of RMCs are related to geographical location of the UE in the cell, some of which are listed below:
Not-at-cell-edge criterion,
Low mobility and not-at-cell edge,
Stationary and not-at-cell edge.

RMCs comprise one or more measurement thresholds that the UE evaluates using the serving cell measurements. In one example, relaxed measurement criterion for UE not-at-cell-edge is fulfilled when the received signal level at the UE from a cell (e.g., serving cell) is above a threshold, e.g., signal strength is above signal strength threshold (S_{SearchThresholdP}) and/or signal quality is above signal quality threshold (S_{SearchThresholdQ}).

When the UE also meets at least one RMC, then the UE performs measurements on one or more neighbor cells following the relaxed measurement requirements associated with that RMC.

According to one aspect of the UE embodiment, UE applies an offset to the measurements used for evaluating the RMC based on the receiver type used for the measurement and based on the type of RMC evaluated. Since the measurements performed using the WUR receiver are expected to have coarser measurement performance (e.g. higher measurement inaccuracy, higher noise figure) compared to those performed using the main receiver, the UE may experience a smaller cell size/coverage compared to when using the main receiver. Consequently, the UE may not correctly evaluate certain types of RMC, in particular those related to geographical location of the UE in the cell and may therefore not be able to operate in power saving mode. The methods in this UE embodiment allow the UE to apply an offset to those measured values when evaluating the RMC (i.e. those which are related to the geographical location of the UE in the cell) based on the receiver type to enable the UE to operate in power saving mode.

In one specific example, UE first determines the type of RMC evaluated and type of receiver used for performing the measurements, and based on that information, applies an offset of +X dB to the measured value (e.g., RSRP, RSRQ, etc.) used for evaluating that RMC. The value of X can be predefined or preconfigured and may correspond to the difference in measurement performance between the WUR receiver and the main receiver. The sign of X can be positive or negative and may further depend on receiver type. The value of X may further depend on the type of receiver, e.g., X1 dB for WUR and X2 dB for the main receiver. In one example, UE applies a positive offset to the measured value from a WUR receiver while it applies a negative offset to the measured value from the main receiver. This would prevent UE switching between the relaxed and non-relaxed mode frequently, i.e., avoiding a ping-pong effect. In another example, the UE applies the offset (e.g., X1 dB) only to the measured value obtained by WUR and does not apply any offset to the measured value obtained by the main receiver. In yet another example, the UE applies the offset (e.g., X2 dB) only to the measured value obtained by the main receiver and does not apply any offset to the measured value obtained by the WUR receiver.

In another example, the UE selects the thresholds for evaluating certain types of RMC (i.e., those related to geographical location of the UE in the cell) based on the receiver type. In one specific example, if the measurements used for evaluating the RMC are performed using the main receiver, UE uses one set of thresholds (e.g., S_{SearchThresholdP-A}, S_{SearchThresholdQ-A}) for evaluating the RMC. But if the measurements are performed using the WUR receiver, then the UE uses a different set of thresholds for evaluating the RMC (e.g. S_{SearchThresholdP-B}, S_{SearchThresholdQ-B}), where S_{SearchThresholdP-A}>S_{SearchThresholdP-B} and/or S_{SearchThresholdQ-A}>S_{SearchThresholdQ-B}.

According to a second aspect of the UE embodiment, relaxation factor (N) of the neighbour cell measurements is adapted to the WUR activity level. N is used to determine how frequently the UE is required to measure the neighbour cells, e.g., a large value of N indicates that the UE can stay in sleep mode for a longer time compared to a smaller value of N. The WUR activity level can be defined by paging cycle, WUR inactivity configuration such as WUR DRX. By aligning the relaxation factor (N) to the WUR activity level, UE does have not to wake up frequently to measure the neighbour cells and this allows the UE to operate in a relaxed mode for a longer time.

In the existing 3GPP specification, when RMCs are fulfilled by the UE, the UE is allowed to apply certain measurement relaxation in time to perform the measurements less frequently to save power. In one alternative to the above, similar RMCs are applied to UE with WUR but to determine when the UE is allowed to use WUR for mobility measurements rather than to determine when measurement relaxations can be applied. That is, similar conditions, e.g., ‘Stationary and not-at-cell edge’, are used but with different WUR-specific thresholds and parameters, and if fulfilled the UE is allowed to use WUR for mobility measurements instead of the main receiver.

Some embodiments herein are applicable in the following context, e.g., according to 3GPP embodiments.

A UE shall perform measurements for cell selection and reselection purposes.

When evaluating Srxlev and Squal of non-serving cells for reselection evaluation purposes, the UE shall use parameters provided by the serving cell and for the final check on cell selection criterion, the UE shall use parameters provided by the target cell for cell reselection.

When camped on a cell, the UE shall regularly search for a better cell according to the cell reselection criteria. If a better cell is found, that cell is selected. The change of cell may imply a change of radio access technology (RAT).

### Cell Selection

After a UE has switched on and a PLMN has been selected, the Cell selection process takes place, as otherwise described in TS 38.304 v17.2.0. This process allows the UE to select a suitable cell where to camp on in order to access available services. In this process, the UE can use stored information (Stored information cell selection) or not (Initial cell selection).

### Cell Re-Selection

The cell reselection procedure allows the UE to select a more suitable cell and camp on it. When the UE is in either Camped Normally state or Camped on Any Cell state on a cell, the UE shall attempt to detect, synchronise, and monitor intra-frequency, inter-frequency and inter-RAT cells indicated by the serving cell. For intra-frequency and inter-frequency cells the serving cell may not provide explicit neighbour list but carrier frequency information and bandwidth information only. UE measurement activity is also controlled by measurement rules defined in TS 38.304, allowing the UE to limit its measurement activity.

For normal service, a UE shall camp on a suitable cell, monitor control channel(s) of that cell so that the UE can receive system information from the PLMN or Standalone NPN (SNPN), receive registration area information from the PLMN or SNPN, e.g., tracking area information, and receive other access stratum (AS) and non-access stratum (NAS) Information. If registered, the a UE shall camp on a suitable cell, monitor control channel(s) of that cell so that the UE can receive paging and notification messages from the PLMN or SNPN and initiate transfer to Connected mode.

Wake-up receiver (WUR), sometimes also referred to as ‘wake-up radio’) is about enabling a low power receiver in UEs, which, in case of the detection of a wake-up signal (WUS), wakes up the main (baseband/higher power) receiver to detect an incoming message, typically paging (e.g., Physical Downlink Control Channel, PDCCH, in paging occasions (PO), scheduling the paging message on Physical Downlink Shared Channel, PDSCH). The main benefit of employing WUR is lowering energy consumption and increasing device battery life, or at a fixed energy consumption, the downlink latency can be reduced (shorter DRX/duty-cycles and more frequent checks for incoming transmissions).

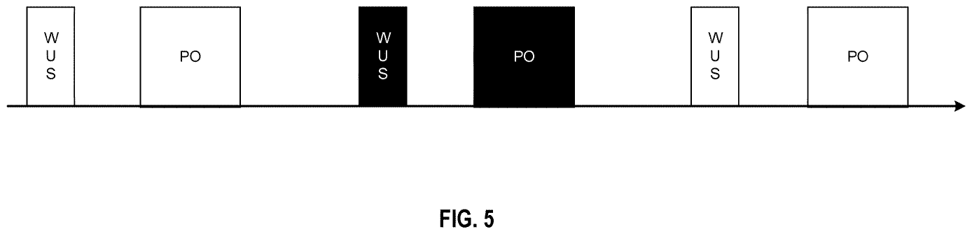

FIG. 5 for example illustrates the location of a WUS and the paging occasion to which it is associated. Here, white blocks indicate possible WUS and PO positions whereas the black boxes indicate actual WUS and PO positions.

### WUS for NB-IoT and LTE-M

### Release 15

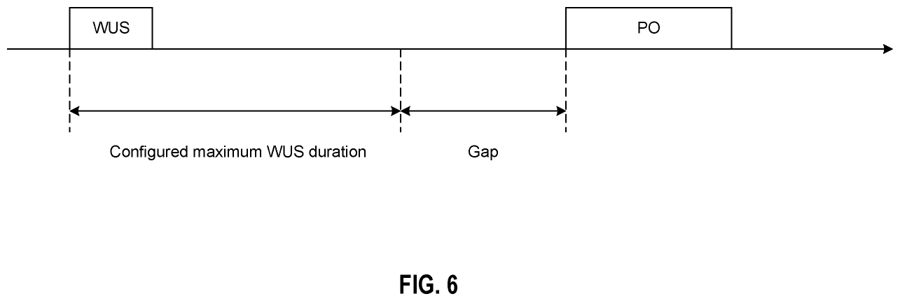

Some embodiments herein are applicable to WUS as specified in Rel-15 for Narrowband Internet of Things (NB-IoT) and Long Term Evolution Machine Type Communication (LTE-M). The main motivation was UE energy consumption reduction since with the coverage enhancement PDCCH could be repeated many times and the WUS is relatively much shorter and hence requires less reception time for the UE. The logic is that a UE would check for a WUS a certain time before its PO, and only if a WUS is detected the UE would continue to check for PDCCH in the PO, and if not, which is most of the time, the UE can go back to a sleep state to conserve energy. Due to the coverage enhancements the WUS can be of variable length depending on the UE's coverage, see FIG. 6.

In some embodiments, a ‘Wake-up signal’ (WUS) is based on the transmission of a short signal that indicates to the UE that it should continue to decode the downlink (DL) control channel e.g., full Narrowband PDCCH, NPDCCH, for NB-IoT. If such signal is absent (DTX, i.e., UE does not detect it) then the UE can go back to sleep without decoding the DL control channel. The decoding time for a WUS is considerably shorter than that of the full NPDCCH since it essentially only needs to contain one bit of information, whereas the NPDCCH may contain up to 35 bits of information. This, in turn, reduces UE power consumption and leads to longer UE battery life. The WUS would be transmitted only when there is a paging for the UE. But if there is no paging for the UE, then the WUS will not be transmitted (i.e., implying a discontinuous transmission, DTX) and the UE would go back to deep sleep e.g., upon detecting DTX instead of WUS.

The specification of Rel-15 WUS is spread out over several parts of the LTE 36-series standard, e.g., TS 36.211 V15.14.0, TS 36.213 V15.16.0, TS 36.304 V15.8.0, and TS 36.331 V15.19.0.

A UE will report its WUS capability to the network, and WUS gap capability (see below). Further WUS information was added to the paging message/request from MME to eNB (see UE radio paging capabilities). eNB will use WUS for paging the UE if and only if (IFF) 1) WUS is enabled in the cell (i.e., WUS-Config present in SI), and 2) the UE supports WUS according to the wakeUpSignal-r15 UE capability (see also the description of WUS gap below).

Some embodiments herein are also applicable for both LTE-M and NB-IoT with support for both DRX and eDRX, the former with a 1-to-1 mapping between the WUS and the PO, and for the latter in addition with the possible configuration of 1-to-N (many) POs. eNB can configure one WUS gap for UEs using DRX, and another one for UEs using eDRX [TS 36.331, examples are given for NB-IoT, LTE-M is similar]:

WUS-Config-NB information element

| | |
|---|---|
| WUS-Config-NB-r15 ::= | SEQUENCE { |
| maxDurationFactor-r15 | WUS-MaxDurationFactor-NB-r15, |
| numPOs-r15 | ENUMERATED {n1, n2, n4} DEFAULT n1, |
| numDRX-CyclesRelaxed-r15 | ENUMERATED {n1, n2, n4, n8}, |
| timeOffsetDRX-r15 | ENUMERATED {ms40, ms80, ms160, ms240}, |
| timeOffset-eDRX-Short-r15 | ENUMERATED {ms40, ms80, ms160, ms240}, |
| timeOffset-eDRX-Long-r15 | ENUMERATED {ms1000, ms2000} OPTIONAL, |
| -- Need OP | |
| . . . | |
| } | |
| WUS-ConfigPerCarrier-NB-r15 ::= | SEQUENCE { |
| maxDurationFactor-r15 | WUS-MaxDurationFactor-NB-r15 |
| } | |
| WUS-MaxDurationFactor-NB-r15 ::= | ENUMERATED {one128th, one64th, one32th, |

one 16th, oneEighth, oneQuarter, oneHalf}

WUS-Config-NB field descriptions

timeOffsetDRX
When DRX is used, non-zero gap from the end of the configured maximum WUS
duration to the associated PO, see TS 36.304, clause 7.4 and TS 36.211. In
milliseconds. Value ms40 corresponds to 40 ms, value ms80 corresponds to 80 ms
and so on.
timeOffset-eDRX-Short
When eDRX is used, the short non-zero gap from the end of the configured maximum
WUS duration to the associated PO, see TS 36.304, clause 7.4 and TS 36.211]. In
milliseconds. Value ms40 corresponds to 40 ms, value ms80 corresponds to 80 ms
and so on.
E-UTRAN configures timeOffset-eDRX-Short to a value longer than or equal to
timeOffsetDRX.
timeOffset-eDRX-Long
When eDRX is used, the long non-zero gap from the end of the configured maximum
WUS duration to the associated PO, see TS 36.304, clause 7.4 and TS 36.211. In
milliseconds. Value ms1000 corresponds to 1000 ms, value ms2000 corresponds to
2000 ms.

The UE capabilities can also indicate the minimum WUS gaps required for the UE to be able to decode PDCCH in the associated PO, for DRX and eDRX, respectively [TS 36.331]:

UE-RadioPagingInfo-NB information element

| UE-RadioPagingInfo-NB-r13 ::= | SEQUENCE { | |
|---|---|---|
| ue-Category-NB-r13 | ENUMERATED {nb1} | OPTIONAL, |
| . . . , | | |
| [[ multiCarrierPaging-r14 | ENUMERATED {true} | OPTIONAL |
| ]], | | |
| [[ mixedOperationMode-r15 | ENUMERATED {supported} | OPTIONAL, |
| wakeUpSignal-r15 | ENUMERATED {true} | OPTIONAL, |
| wakeUpSignalMinGap-eDRX-r15 | ENUMERATED {ms40, ms240, ms1000, ms2000} | |
| | OPTIONAL, | |
| multiCarrierPagingTDD-r15 | ENUMERATED {true} | OPTIONAL |
| ]], | | |
| [[ ue-Category-NB-r16 | ENUMERATED {nb2} | OPTIONAL, |
| groupWakeUpSignal-r16 | ENUMERATED {true} | OPTIONAL, |
| groupWakeUpSignalAlternation-r16 | ENUMERATED {true} | OPTIONAL |
| ]] | | |
| } | | |

wakeUpSignalMinGap-eDRX

Indicates the minimum gap the UE supports between WUS or GWUS and associated PO in case of eDRX in FDD, as specified in TS 36.304. Value ms40 corresponds to 40 ms, value ms240 corresponds to 240 ms and so on. If this field is included, the UE shall also indicate support for WUS or GWUS for paging in DRX.

Some embodiments herein are also applicable for a longer WUS gap of 1 s or 2 s, e.g., to enable the use of WUR. Indeed, starting up the main baseband receiver if a WUR is used for the detection of WUS may take longer time. If this is supported in the cell, eNB would include timeOffset-eDRX-Long in the WUS-Config in system information (SI) (see above). In TS 36.304 V17.2.0, the UE behavior for monitoring paging with WUS is specified, and in Table 7.4-1 it is indicated which WUS time gap the UE (and eNB) should apply depending on the reported UE capability:

7.4 Paging with Wake Up Signal
Paging with Wake Up Signal is only used in the cell in which the UE most recently entered RRC_IDLE triggered by:
reception of RRCEarlyDataComplete; or
reception of RRCConnectionRelease not including noLastCellUpdate; or
reception of RRCConnectionRelease including noLastCellUpdate and the UE was using (G)WUS in this cell prior to this RRC connection attempt.
   If the UE is in RRC_IDLE, the UE is not using GWUS according to clause 7.5 and the UE supports WUS and WUS configuration is provided in system information, the UE shall monitor WUS using the WUS parameters provided in System Information. When DRX is used and the UE detects WUS the UE shall monitor the following PO. When extended DRX is used and the UE detects WUS the UE shall monitor the following numPOs POs or until a paging message including the UE's NAS identity is received, whichever is earlier. If the UE does not detect WUS the UE is not required to monitor the following PO(s). If the UE missed a WUS occasion (e.g. due to cell reselection), it monitors every PO until the start of next WUS or until the PTW ends, whichever is earlier.
numPOs=Number of consecutive Paging Occasions (PO) mapped to one WUS provided in system information where (numPOs>1).
   The WUS configuration, provided in system information, includes time-offset between end of WUS and start of the first PO of the numPOs POs UE is required to monitor. The timeoffset in subframes, used to calculate the start of a subframe g0 (see TS 36.213), is defined as follows:
for UE using DRX, it is the signalled timeoffsetDRX;
for UE using eDRX, it is the signalled timeoffset-eDRX-Short if timeoffset-eDRX-Long is not broadcasted;
for UE using eDRX, it is the value determined according to Table 7.4-1 if timeoffset-eDRX-Long is broadcasted

TABLE 7.4-1
Determination of GAP between end of WUS and associated PO

| | | | timeoffset-eDRX-Long | |
|---|---|---|---|---|
| | | | 1000 ms | 2000 ms |
| UE Reported | 40 ms or not | | timeoffset- | timeoffset- |
| wakeUpSignalMinGap- | reported | | eDRX-Short | eDRX-Short |
| eDRX | 240 | ms | timeoffset- | timeoffset- |
| | | | eDRX-Short | eDRX-Short |
| | 1000 | ms | timeoffset- | timeoffset- |
| | | | eDRX-Long | eDRX-Long |
| | 2000 | ms | timeoffset- | timeoffset- |
| | | | eDRX-Short | eDRX-Long |

The timeoffset is used to determine the actual subframe g0 as follows (taking into consideration resultant SFN and/or H-SFN wrap-around of this computation):
g0=PO−timeoffset, where PO is the Paging Occasion subframe as defined in clause 7.1

For UE using eDRX, the same timeoffset applies between the end of WUS and associated first PO of the numPOs POs for all the WUS occurrences for a PTW.

The timeoffset, g0, is used to calculate the start of the WUS as defined in TS 36.213.

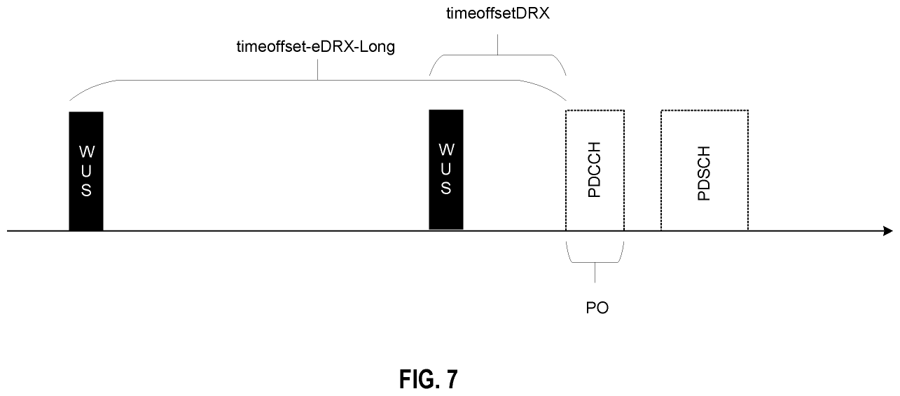

In some embodiments, the UE will only use WUR, or timeOffset-eDRX-Long, if it is capable of starting up the main receiver as quickly as indicated by the value used in SI. If not, it will fall back to using timeOffset-eDRX-Short (without WUR). FIG. 7 in this regard shows timeOffset-eDRX-Long in related to timeOffsetDRX, where eDRX and DRX WUS gaps are used for NB-IoT and LTE-M.

Since UEs share PO, the eNB may, in the worst case, have to transmit up to 3 WUSs for one PO. I.e., corresponding to timeoffsetDRX, timeoffset-eDRX-Short, and timeoffset-eDRX-Long.

### WUS UE Grouping Objective in Rel-16

Some embodiments are applicable for UE-group WUS, such that the number of UEs that are triggered by a WUS is further narrowed down to a smaller subset of the UEs that are associated with a specific paging occasion (PO). This provides improved DL transmission efficiency and/or UE power consumption.

The purpose is to reduce the false paging rate, i.e., avoid that a given UE is unnecessarily woken up by a WUS transmission intended for another UE. This feature is referred to as Rel-16 group WUS, or GWUS.

### Rel-17 NR PEI

Some embodiments herein are further applicable for Rel-17 WUS for NR, then called ‘Paging Early Indication’ (PEI). However, since at the time no coverage enhancement was specified for NR, the only gain for Rel-17 PEI was for scenarios where the small fraction of UEs are in bad coverage and with large synchronization error due to the use of longer DRX cycles. The gain for such UEs was that with the use of PEI they would typically only have to acquire one SSB before decoding PEI, instead of up to 3 SSBs if PEI is not used (value according to UE vendors). So, for most UEs, Rel-17 PEI will result in gains or increased performance.

However, PEI will be PDCCH-based.

### Rel-18 NR WUR

Some embodiments herein are applicable for WUR for New Radio (NR) according to 3GPP Rel-18. The only specification support needed to be able to use a WUR in the UE, is the specification of a WUS and a long enough time gap between the WUS and the PDCCH in the PO (to allow the UE to start up the main receiver). Therefore, the main difference to Rel-17 PEI is the WUS in Rel-18 should not be PDCCH-based and allow for a simpler and low power receiver, i.e., WUR with simple modulation and detection techniques (e.g., using on-off keying (OOK) modulation and non-coherent detection).

5G systems in this regard are designed and developed targeting for both mobile telephony and vertical use cases. Besides latency, reliability, and availability, UE energy efficiency is also critical to 5G. Currently, 5G devices may have to be recharged per week or day, depending on individual's usage time. In general, 5G devices consume tens of milliwatts in RRC idle/inactive state and hundreds of milliwatts in RRC connected state. Designs to prolong battery life is a necessity for improving energy efficiency as well as for better user experience.

Energy efficiency is even more critical for UEs without a continuous energy source, e.g., UEs using small rechargeable and single coin cell batteries. Among vertical use cases, sensors and actuators are deployed extensively for monitoring, measuring, charging, etc. Generally, their batteries are not rechargeable and expected to last at least few years as described in TR 38.875. Wearables include smart watches, rings, eHealth related devices, and medical monitoring devices. With typical battery capacity, it is challenging to sustain up to 1-2 weeks as required.

The power consumption depends on the configured length of wake-up periods, e.g., paging cycle. To meet the battery life requirements above, eDRX cycle with large value is expected to be used, resulting in high latency, which is not suitable for such services with requirements of both long battery life and low latency. For example, in fire detection and extinguishment use case, fire shutters shall be closed and fire sprinklers shall be turned on by the actuators within 1 to 2 seconds from the time the fire is detected by sensors, long eDRX cycle cannot meet the delay requirements. eDRX is apparently not suitable for latency-critical use cases. Thus, the intention is to study ultra-low power mechanism that can support low latency in Rel-18, e.g. lower than eDRX latency.

Traditionally, UEs need to periodically wake up once per DRX cycle, which dominates the power consumption in periods with no signalling or data traffic. If UEs are able to wake up only when they are triggered, e.g., paging, power consumption could be dramatically reduced. This can be achieved by using a wake-up signal to trigger the main radio and a separate receiver which has the ability to monitor wake-up signal with ultra-low power consumption. Main radio works for data transmission and reception, which can be turned off or set to deep sleep unless it is turned on.

The power consumption for monitoring wake-up signal depends on the wake-up signal design and the hardware module of the wake-up receiver used for signal detecting and processing.

Some embodiments herein therefore target low-power WUS/WUR for power-sensitive, small form-factor devices including internet of things (IoT) use cases (such as industrial sensors, controllers) and wearables. Other use cases are not precluded, e.g. XR/smart glasses, smart phones.

For more details on e.g., suggestions on WUR architecture and design, receiver power vs. sensitivity trade-off, see e.g., RP-212005, RP-212254, RP-212367, and RP-212427.

The benefit of WUR is to reduce the energy consumption of the receiver, such that unless there is any paging and data for the UE it can remain in a power saving state. This will extend the battery life of the device, or alternatively enable shorter downlink latency (shorter DRX) at a fixed battery life. For short-range communication, the WUR power can be low enough (~3 uW) that this can even, in combination with energy harvesting, enable the WUR continuously on (i.e. DRX or duty-cycling is not used) without the need for a battery. This can be considered as a key enabler of battery-less devices towards 6G.

### NR L3 Measurements

Some embodiments are applicable for measurements as specified below. In NR, UE are supported to measure SS-RSRP and SS-RSRQ as L3 measurement.

### SS-RSRP

The definition of SS-RSRP is given in TS 38.215 V17.2.0 as follows.

SS reference signal received power (SS-RSRP) is defined as the linear average over the power
contributions (in [W]) of the resource elements that carry secondary synchronization
signals. The measurement time resource(s) for SS-RSRP are confined within SS/PBCH
Block Measurement Time Configuration (SMTC) window duration. If SS-RSRP is used for
L1-RSRP as configured by reporting configurations as defined in TS 38.214 [6], the
measurement time resources(s) restriction by SMTC window duration is not applicable.
For SS-RSRP determination demodulation reference signals for physical broadcast
channel (PBCH) and, if indicated by higher layers, CSI reference signals in addition to
secondary synchronization signals may be used. SS-RSRP using demodulation reference
signal for PBCH or CSI reference signal shall be measured by linear averaging over the
power contributions of the resource elements that carry corresponding reference signals
taking into account power scaling for the reference signals as defined in TS 38.213 [5]. If
SS-RSRP is not used for L1-RSRP, the additional use of CSI reference signals for
SS-RSRP determination is not applicable.
SS-RSRP shall be measured only among the reference signals corresponding to SS/PBCH
blocks with the same SS/PBCH block index and the same physical-layer cell identity.
If SS-RSRP is not used for L1-RSRP and higher-layers indicate certain SS/PBCH
blocks for performing SS-RSRP measurements, then SS-RSRP is measured only from the
indicated set of SS/PBCH block(s).
For frequency range 1, the reference point for the SS-RSRP shall be the antenna
connector of the UE. For frequency range 2, SS-RSRP shall be measured based on the combined
signal from antenna elements corresponding to a given receiver branch. For frequency range
1 and 2, if receiver diversity is in use by the UE, the reported SS-RSRP value shall not be
lower than the corresponding SS-RSRP of any of the individual receiver branches.

One example of SS-RSRP calculation for SS/PBCH block occasion j is provided by:

$${RSRP}_{j} = \frac{1}{{N}_{SSS}} {\sum }_{k = 1}^{{N}_{SSB}} {\vert {h}_{SSS , j} ( k ) \vert}^{2}$$

where, h_{SSS,j}(k) is the channel estimate corresponding to SSS in the resource element k in SS/PBCH block occasion j, and N_{SSB} is the number of SSS resource elements, e.g., 127.

UE may take average of RSRP over the recent M S/Pe CH block reception occasions, like

$$RSRP = \frac{1}{M} {\sum }_{j = 1}^{M} {RSRP}_{j}$$

In the special case, M=1, which means UE performs RRM processing only from the latest SS/PBCH block reception occasion.

### SS-RSRQ

The definition of SS-RSRQ is given in T38.215 V17.2.0 as follows.

Secondary synchronization signal reference signal received quality (SS-RSRQ) is
defined as the ratio of N × SS-RSRP/NR carrier RSSI, where N is the number of
resource blocks in the NR carrier RSSI measurement bandwidth. The measurements in
the numerator and denominator shall be made over the same set of resource blocks.
NR carrier Received Signal Strength Indicator (NR carrier RSSI), comprises the
linear average of the total received power (in [W]) observed only in certain OFDM
symbols of measurement time resource(s), in the measurement bandwidth, over N
number of resource blocks from all sources, including co-channel serving and
non-serving cells, adjacent channel interference, thermal noise etc. For cell selection,
according to Clause 4.1 of TS 38.211 [12], the measurement time resources(s) for NR
Carrier RSSI are not constrained. Otherwise, the measurement time resource(s) for NR
Carrier RSSI are confined within SS/PBCH Block Measurement Time Configuration
(SMTC) window duration.
If indicated by higher-layers, if measurement gap is not used, the NR Carrier
RSSI is measured in slots within the SMTC window duration that are indicated by the
higher layer parameter measurementSlots and in OFDM symbols given by Table 5.1.3-1
and, if measurement gap is used, the NR Carrier RSSI is measured in slots within the
SMTC window duration that are indicated by the higher layer parameter
measurementSlots and in OFDM symbols given by Table 5.1.3-1 that are overlapped
with the measurement gap, which is defined in TS38.133 [12].
For intra-frequency measurements, NR Carrier RSSI is measured with timing
reference corresponding to the serving cell in the frequency layer
For inter-frequency measurements, NR Carrier RSSI is measured with timing
reference corresponding to any cell in the target frequency layer
Otherwise not indicated by higher-layers, if measurement gap is not used, NR
Carrier RSSI is measured from OFDM symbols within SMTC window duration and, if
measurement gap is used, NR Carrier RSSI is measured from OFDM symbols
corresponding to overlapped time span between SMTC window duration and the
measurement gap.
If higher-layers indicate certain SS/PBCH blocks for performing SS-RSRQ
measurements, then SS-RSRP is measured only from the indicated set of SS/PBCH
block(s).
For frequency range 1, the reference point for the SS-RSRQ shall be the antenna
connector of the UE. For frequency range 2, NR Carrier RSSI shall be measured based
on the combined signal from antenna elements corresponding to a given receiver
branch, where the combining for NR Carrier RSSI shall be the same as the one used for
SS-RSRP measurements. For frequency range 1 and 2, if receiver diversity is in use by
the UE, the reported SS-RSRQ value shall not be lower than the corresponding
SS-RSRQ of any of the individual receiver branches.

One example of SS-RSRQ calculation at time t is provided by:

$${RSRQ}_{j} = \frac{N \times {RSRP}_{j}}{{RSSI}_{j}}$$

Where RSSIⱼ is given by

$${RSSI}_{j} = \frac{1}{T} {\sum }_{t = 1}^{T} {\sum }_{k = 1}^{K} {\vert {r}_{j} ( t , k ) \vert}^{2}$$

Where rⱼ(t,k) is the received OFDM symbol in resource element k in time t in SS/PBCH block occasion j, K is the number of subcarriers in the measurement resource blocks (N) to measure RSSI, and T is the number of OFDM symbols in time used for RSSI calculation. For example, N=20 (corresponding to resource blocks for SS/PBCH block transmission), K=240 (=12×N), and T=4 (corresponding to OFDM symbols to transmit SS/PBCH block).

UE may take average of RSRQⱼ over the recent M SS/PBCH block reception occasions like

$$RSRQ = \frac{1}{M} {\sum }_{j = 1}^{M} {RSRQ}_{j}$$

In the special case, M=1, which means UE performs RRM processing only from the latest SS/PBCH block reception occasion.

In this context, some embodiments herein are applicable for solving the following problem. The WUR gains come from allowing the main receiver to stay in a power saving state. The longer the main receiver can stay in such a sleep state, the bigger the gain. In addition, a deeper sleep state, e.g., an “ultra-deep sleep state”, where more functionality and hardware can be shut down will further increase the WUR gain, at the expense of a longer start up time (i.e., longer transition time and higher transition energy).

A UE however is heretofore required to perform serving cell measurements periodically to ensure it is camping on the best cell, see TS 38.133 V17.7.0 Clause 4.2.2.2:

The UE shall measure the SS-RSRP and SS-RSRQ level of the serving
cell and evaluate the cell selection criterion S defined in TS 38.304 [1]
for the serving cell at least once every M1*N1 DRX cycle; where:
M1 = 2 if SMTC periodicity (T_{SMTC}) > 20 ms and DRX cycle ≤ 0.64
second, otherwise M1 = 1.

For example, in FR1 (operating bands less than 7.125 GHz), N1=1 and there a UE must perform serving cell measurements once every DRX cycle, or once every 2^{nd} DRX cycle. If the main receiver has to be started up for these measurements, most of the WUR gains for power saving will heretofore be lost. For example, WUR can provide over 80% power saving gain if the main receiver does not regularly perform measurements. However, the WUR power saving gain falls below 20% if the main receiver wakes up once every 2^{nd} DRX cycle for performing measurements. Accordingly, the benefit of employing WUR is highly dependent on whether RRM measurements are done by the main receiver or not.

Therefore, to exploit WUR gains, it is beneficial if a more capable WUR can be supported in Rel-18 which can also perform RRM measurements (on top of the serving cell measurements mentioned above, the UE must in addition perform neighbour cell measurements if the serving cell RSRP is below a configurable threshold, i.e., on the “cell-edge”). However, challenges exist for how to realize WUR mobility measurements since at least the receiver sensitivity can be different for the main receiver and the WUR, and the measurement accuracy can be different.

Certain aspects of the disclosure and their embodiments may provide solutions to these or other challenges. Some embodiments adapt the cell (re-)selection criterion and/or RRM measurements to enable mobility measurements by WUR. The adaptation can either be the application of a new WUR compensation (offset) added to the (SS-)RSRP and (SS-)RSRQ measurements done using the WUR, new WUR specific minimum signal strength or signal quality levels applies to the legacy cell selection criterion S, or application of separate cell selection criterion S when the UE use WUR for mobility measurements.

Certain embodiments may provide one or more of the following technical advantage(s): (i) Enabling UEs equipped with WUR to achieve a significant power saving gain by minimizing the main receiver wake up events and increasing its sleep time; (ii) exploiting the benefits of employing WUR in terms of power saving and latency and ensuring its applicability in various scenarios; (iii) enhancing design flexibility by addressing the tradeoff between WUR coverage/sensitivity and power consumption. Generally, some embodiments lead to a significant power saving gain which provides more room for increasing WUR power consumption itself and using more capable WUR with a better sensitivity.

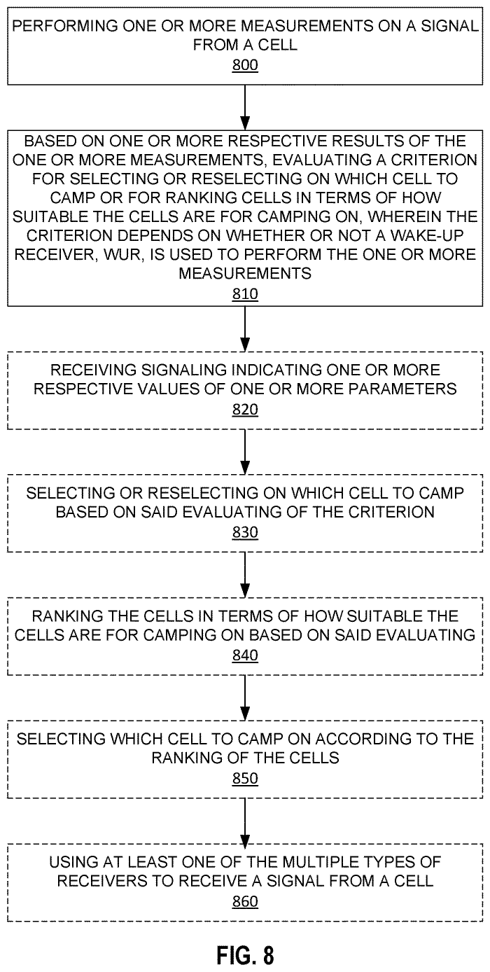

In view of the modifications and variations herein, FIG. 8 depicts a method performed by a communication device 12 in accordance with particular embodiments. The method includes performing one or more measurements M-1 . . . M-N on a signal 24 from a cell 26 (Block 800). The method also comprises, based on one or more respective results of the one or more measurements M-1 . . . M-N, evaluating a criterion C for selecting or reselecting on which cell 26 to camp or for ranking cells 26 in terms of how suitable the cells 26 are for camping on, wherein the criterion C depends on whether or not a wake-up receiver, WUR, 12W is used to perform the one or more measurements M-1 . . . M-N (Block 810).

In some embodiments, the criterion C is for selecting or reselecting on which cell 26 to camp. In some embodiments the criterion C is fulfilled when, for each of the one or more measurements M-1 . . . M-N, a condition on a cell selection or reselection measurement value calculated from a result of the measurement is met. In some embodiments, for each of the one or more measurements M-1 . . . M-N, the respective cell selection or reselection measurement value depends on whether or not the WUR 12W is used to perform the measurement. In some embodiments, for each of the one or more measurements M-1 . . . M-N, the respective cell selection or reselection measurement value is a function of the result of the measurement and a WUR-dependent parameter whose value depends on whether or not the WUR 12W is used to perform the measurement. In some embodiments, for each of the one or more measurements M-1 . . . M-N, the WUR-dependent parameter of which the respective cell selection or reselection measurement value is a function is a minimum required level of the result of the measurement in the cell 26. In other embodiments, for each of the one or more measurements M-1 . . . M-N, the WUR-dependent parameter of which the respective cell selection or reselection measurement value is a function is an offset to a minimum required level of the result of the measurement in the cell 26. In yet other embodiments, for each of the one or more measurements M-1 . . . M-N, the WUR-dependent parameter of which the respective cell selection or reselection measurement value is a function is an offset to the result of the measurement in the cell 26. In some embodiments, for each of the one or more measurements M-1 . . . M-N, the WUR-dependent parameter of which the respective cell selection or reselection measurement value is a function is specific to a type of the communication device 12 or a type of WUR 12W used to perform the measurement. In some embodiments, the criterion C is a criterion for selecting the cell 26 as the cell 26 to camp on, wherein the one or more measurements M-1 . . . M-N include a reference signal received power, RSRP, measurement and/or a reference signal received quality, RSRQ, measurement. In some embodiments, for the RSRP measurement, the WUR-dependent parameter is an offset Q_{rxlevminoffset}^{WUR} comprising an offset to a minimum required RSRP level Qᵣₓₗₑᵥₘᵢₙ in the cell 26 if the WUR 12W is used to perform the RSRP measurement. In other embodiments, for the RSRQ measurement, the WUR-dependent parameter is alternatively or additionally an offset Q_{qualminoffset}^{WUR} comprising an offset to a minimum required RSRQ level Q_{qualmin} in the cell 26 if the WUR 12W is used to perform the RSRQ measurement. In some embodiments, the criterion C is a criterion for selecting the cell 26 as the cell 26 to camp on, wherein the one or more measurements M-1 . . . M-N include a reference signal received power, RSRP, measurement and/or a reference signal received quality, RSRQ, measurement. In some embodiments, for the RSRP measurement, the WUR-dependent parameter is a minimum required RSRP level Qᵣₓₗₑᵥₘᵢₙ^{WUR} in the cell 26 if the WUR 12W is used to perform the RSRP measurement. In other embodiments, for the RSRQ measurement, the WUR-dependent parameter is alternatively or additionally a minimum required RSRQ level Q_{qualmin}^{WUR} in the cell 26 if the WUR 12W is used to perform the RSRQ measurement. In some embodiments, the method further comprises receiving signaling indicating one or more respective values of one or more parameters (Block 820). In some embodiments, a value of the WUR-dependent parameter is based on said one or more parameters. In some embodiments, said value of the WUR-dependent parameter is a function of a difference between a sensitivity of the WUR 12W and a sensitivity of at least one other type of receiver. In some embodiments, said value of the WUR-dependent parameter is a function of said one or more parameters. In some embodiments, in said function, said one or more parameters scale and/or bias the difference between the sensitivity of the wake-up receiver and the sensitivity of the at least one other type of receiver.

In some embodiments, the criterion C is for selecting or reselecting on which cell 26 to camp. In some embodiments, the criterion C is fulfilled when, for each of the one or more measurements M-1 . . . M-N, a condition on a cell selection or reselection measurement value calculated from a result of the measurement is met. In some embodiments, the condition depends on whether or not the WUR 12W is used to perform the measurement. In some embodiments, for each of the one or more measurements M-1 . . . M-N, the condition on the cell selection or reselection measurement value calculated from the result of the measurement is met when the cell selection or reselection measurement value is greater than a WUR-dependent threshold. In some embodiments, the value of the WUR-dependent threshold depends on whether or not the WUR 12W is used to perform the measurement. In some embodiments, the criterion C is for reselecting on which cell 26 to camp, wherein the cell 26 is a serving cell of the communication device 12. In some embodiments, when the criterion C is fulfilled, the communication device 12 is to reselect on which cell 26 to camp, wherein the one or more measurements M-1 . . . M-N include a reference signal received power, RSRP, measurement and/or a reference signal received quality, RSRQ, measurement. In some embodiments, for the RSRP measurement, the WUR-dependent threshold is a threshold S_{IntraSearchP}. In other embodiments, for the RSRQ measurement, the WUR-dependent threshold is alternatively or additionally a threshold S_{IntraSearchQ}. In some embodiments, the one or more measurements M-1 . . . M-N include a reference signal received power, RSRP, measurement and a reference signal received quality, RSRQ, measurement. In some embodiments, the criterion C is for selecting or reselecting on which cell 26 to camp, and the method further comprises selecting or reselecting on which cell 26 to camp based on said evaluating of the criterion C (Block 830).

In some embodiments, the criterion C is for ranking cells 26 in terms of how suitable the cells 26 are for camping on. In some embodiments, the one or more measurements M-1 . . . M-N comprise a reference signal received power, RSRP, measurement. In some embodiments, the criterion C is a function of a WUR-dependent parameter whose value depends on whether or not the WUR 12W is used to perform the RSRP measurement. In some embodiments, the WUR-dependent parameter is an offset to the result of the RSRP measurement.

In some embodiments, the criterion C is for ranking cells 26 in terms of how suitable the cells 26 are for camping on, and the method further comprises ranking the cells 26 in terms of how suitable the cells 26 are for camping on based on said evaluating (Block 840). In some embodiments, the criterion C is for ranking cells 26 in terms of how suitable the cells 26 are for camping on, and the method further comprises selecting which cell 26 to camp on according to the ranking of the cells 26 (Block 850). In some embodiments, the communication device 12 is equipped with multiple types of receivers, including a WUR 12W, and wherein the method further comprises using at least one of the multiple types of receivers to receive the signal 24 from the cell 26 (Block 860).

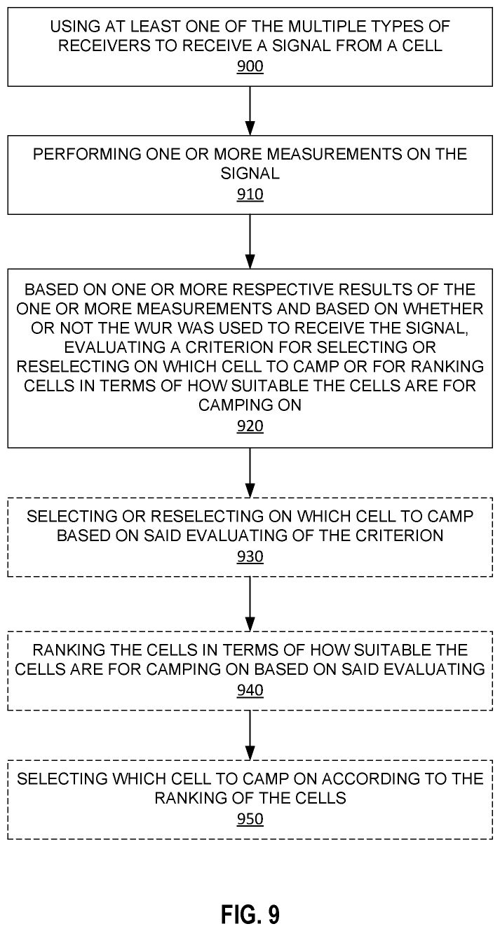

FIG. 9 depicts a method performed by a communication device 12 equipped with multiple types of receivers 12R, 12W, including a wake-up receiver, WUR, 12W in accordance with particular embodiments. The method includes using at least one of the multiple types of receivers 12R, 12W to receive a signal 24 from a cell 26 (Block 900). The method also includes performing one or more measurements M-1 . . . M-N on the signal 24 (Block 910). The method also includes based on one or more respective results M-1 . . . M-N of the one or more measurements M-1 . . . M-N and based on whether or not the WUR 12W was used to receive the signal 24, evaluating a criterion C for selecting or reselecting on which cell 26 to camp or for ranking cells 26 in terms of how suitable the cells are for camping on (Block 920).

In some embodiments, the method includes selecting or reselecting on which cell 26 to camp based on said evaluating of the criterion C (Block 930). In other embodiments, the method includes ranking the cells 26 in terms of how suitable the cells 26 are for camping on based on said evaluating (Block 940). In this embodiment, the method may further include selecting which cell 26 to camp on according to the ranking of the cells 26 (Block 950).

In some embodiments, the criterion C is for selecting or reselecting on which cell 26 to camp. In some embodiments, the criterion C is fulfilled when, for each of the one or more measurements M-1 . . . M-N, a condition on a cell (re)selection measurement value calculated from a result of the measurement is met. In some embodiments, evaluating the criterion C comprises, for each of the one or more measurements M-1 . . . M-N, calculating the respective cell (re)selection measurement value based on whether or not the WUR 12W was used to receive the signal 24. In some embodiments, for each of the one or more measurements M-1 . . . M-N, calculating the respective cell (re)selection measurement value comprises calculating the respective cell (re)selection measurement value as a function of the result of the measurement and a WUR-dependent parameter whose value depends on whether or not the WUR 12W was used to receive the signal 24. In some embodiments, for each of the one or more measurements M-1 . . . M-N, the WUR-dependent parameter based on which the respective cell (re)selection measurement value is calculated is a minimum required level of the result of the measurement in the cell 26. In other embodiments, for each of the one or more measurements M-1 . . . M-N, the WUR-dependent parameter based on which the respective cell (re)selection measurement value is calculated is an offset to a minimum required level of the result of the measurement in the cell 26. In some embodiments, for each of the one or more measurements M-1 . . . M-N, the WUR-dependent parameter based on which the respective cell (re)selection measurement value is calculated is an offset to the result of the measurement in the cell 26. In some embodiments, when the wake-up receiver is used to receive the signal 24, a value of the WUR-dependent parameter based on which each respective cell (re)selection measurement value is calculated is a function of a difference between a sensitivity of the wake-up receiver and a sensitivity of at least one other of the multiple types of receivers. In some embodiments, the method further comprises computing the value of the WUR-dependent parameter based on which each respective cell (re)selection measurement value is calculated, as a function of a difference between a sensitivity of the wake-up receiver and a sensitivity of at least one other of the multiple types of receivers. In some embodiments, said computing comprises computing the value of the WUR-dependent parameter based on which each respective cell (re)selection measurement value is calculated also as a function of one or more parameters that scale and/or bias the difference between the sensitivity of the wake-up receiver and the sensitivity of the at least one other of the multiple types of receivers. In some embodiments, the method further comprises receiving, from a network node, signaling indicating one or more respective values of the one or more parameters. In some embodiments, the sensitivity of the wake-up receiver is specific to the communication device 12 and/or the sensitivity of at least one other of the multiple types of receivers is specific to the communication device 12 and/or is specific to a type of the communication device 12. In some embodiments, for each of the one or more measurements M-1 . . . M-N, the WUR-dependent parameter based on which the respective cell (re)selection measurement value is calculated is specific to the communication device 12 and/or is specific to a type of the communication device 12. In some embodiments, the criterion C is a criterion C for selecting the cell 26 as the cell 26 to camp on. In some embodiments, the one or more measurements M-1 . . . M-N include a reference signal received power, RSRP, measurement and/or a reference signal received quality, RSRQ, measurement. In some embodiments, for the RSRP measurement, the WUR-dependent parameter is an offset Q_{rxlevminoffset}^{WUR} comprising an offset to a minimum required RSRP level Qᵣₓₗₑᵥₘᵢₙ in the cell 26 if the wake-up receiver is used to receive the signal 24. In other embodiments, alternatively or additionally for the RSRW measurement, the WUR-dependent parameter is an offset Q_{qualminoffset}^{WUR} comprising an offset to a minimum required RSRQ level Q_{qualmin} in the cell 26 if the wake-up receiver is used to receive the signal 24. In some embodiments, the criterion C is a criterion C for selecting the cell 26 as the cell 26 to camp on. In some embodiments, the one or more measurements M-1 . . . M-N include a reference signal received power, RSRP, measurement and/or a reference signal received quality, RSRQ, measurement. In some embodiments, for the RSRP measurement, the WUR-dependent parameter is a minimum required RSRP level Qᵣₓₗₑᵥₘᵢₙ^{WUR} in the cell 26 if the wake-up receiver is used to receive the signal 24. In other embodiments, alternatively or additionally for the RSRQ measurement, the WUR-dependent parameter is a minimum required RSRQ level Q_{qualmin}^{WUR} in the cell 26 if the wake-up receiver is used to receive the signal 24. In some embodiments, the criterion C is a criterion for selecting the cell 26 as the cell 26 to camp on, wherein, for each of the one or more measurements M-1 . . . M-N, the condition on the cell (re)selection measurement value calculated from the result of the measurement is met when the cell (re)selection measurement value is greater than zero. In some embodiments, evaluating the criterion C comprises, for each of the one or more measurements M-1 . . . M-N calculating a cell (re)selection measurement value from a result of the measurement. In some embodiments, evaluating the criterion C comprises, for each of the one or more measurements M-1 . . . M-N evaluating whether or not a condition on the cell (re)selection measurement value is met, wherein the condition depends on whether or not the WUR 12W was used to receive the signal 24. In some embodiments, the criterion C is fulfilled when the condition is met for each of the one or more measurements M-1 . . . M-N. In some embodiments, for each of the one or more measurements M-1 . . . M-N, the condition on the cell (re)selection measurement value calculated from the result of the measurement is met when the cell (re)selection measurement value is greater than a WUR-dependent threshold. In some embodiments, the value of the WUR-dependent threshold depends on whether or not the WUR 12W was used to receive the signal 24. In some embodiments, for each of the one or more measurements M-1 . . . M-N, the value of the respective WUR-dependent threshold is a function of a difference between a sensitivity of the wake-up receiver and a sensitivity of at least one other of the multiple types of receivers. In some embodiments, the criterion C is for reselecting on which cell 26 to camp, wherein the cell 26 is a serving cell of the communication device 12. In some embodiments, when the criterion C is fulfilled, the communication device 12 is to reselect on which cell 26 to camp. In some embodiments, the one or more measurements M-1 . . . M-N include a reference signal received power, RSRP, measurement and/or a reference signal received quality, RSRQ, measurement. In some embodiments, for the RSRP measurement, the WUR-dependent threshold is a threshold S_{IntrasearchP}. In other embodiments, alternatively or additionally for the RSRQ measurement, the WUR-dependent threshold is a threshold S_{IntraSearchQ}. In some embodiments, the criterion C evaluated depends on whether or not the WUR 12W was used to receive the signal 24. In some embodiments, the criterion C is for reselecting on which cell 26 to camp. In some embodiments, the cell 26 is a serving cell of the communication device 12, and, when the criterion C is fulfilled, the communication device 12 is to reselect on which cell 26 to camp. In some embodiments, the criterion C is the serving cell fulfilling Srxlev>S_{IntraSearchP} and Squal>S_{IntraSearchQ}.

In some embodiments, the criterion C is for ranking cells 26 in terms of how suitable the cells 26 are for camping on. In some embodiments, evaluating the criterion C comprises calculating the criterion C as a function of whether or not the WUR 12W was used to receive the signal 24. In some embodiments, calculating the criterion C comprises calculating the criterion C as a function of a WUR-dependent parameter whose value depends on whether or not the WUR 12W was used to receive the signal 24. In some embodiments, the WUR-dependent parameter is an offset to the result of the measurement in the cell 26. In some embodiments, a value of the WUR-dependent parameter is a function of a difference between a sensitivity of the wake-up receiver and a sensitivity of at least one other of the multiple types of receivers. In some embodiments, the cell 26 is a serving cell of the communication device 12 and the criterion C is a cell ranking criterion Rₛ for the serving cell 26. In other embodiments, the cell 26 is a neighbor cell of the communication device 12 and the criterion C is a cell ranking criterion Rₙ for the neighbor cell.

In some embodiments, the one or more measurements M-1 . . . M-N include a reference signal received power, RSRP, measurement and a reference signal received quality, RSRQ, measurement.

In some embodiments, the one or more measurements M-1 . . . M-N comprise a single measurement, wherein the single measurement is a reference signal received power, RSRP, measurement.

In some embodiments, the cell 26 is a serving cell of the communication device 12 or a neighbor cell that neighbors a serving cell of the communication device 12.

In some embodiments, the criterion C is for selecting or reselecting on which cell 26 to camp, and the method further comprises selecting or reselecting on which cell 26 to camp based on said evaluating of the criterion C.

In some embodiments, the criterion C is for ranking cells 26 in terms of how suitable the cells 26 are for camping on. In some embodiments, the method further comprises ranking the cells 26 in terms of how suitable the cells 26 are for camping on based on said evaluating, and selecting which cell 26 to camp on according to the ranking of the cells.

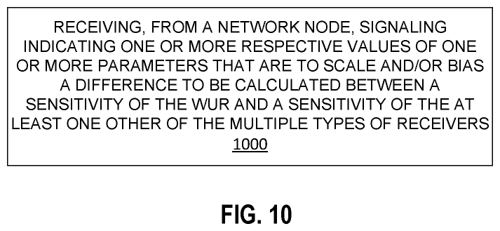

FIG. 10 depicts a method performed by a communication device 12 equipped with multiple types of receivers 12R, 12W, including a wake-up receiver, WUR, 12W in accordance with other particular embodiments. The method includes receiving, from a network node 14, signaling indicating one or more respective values of one or more parameters that are to scale and/or bias a difference to be calculated between a sensitivity of the WUR 12W and a sensitivity of the at least one other of the multiple types of receivers 12R (Block 1000).

In some embodiments, the method further comprises calculating the difference between the sensitivity of the WUR 12W and the sensitivity of the at least one other of the multiple types of receivers. In some embodiments, the method further comprises scaling and/or biasing the calculated difference using the one or more respective values of the one or more parameters indicated by the received signaling.

In some embodiments, the method further comprises using at least one of the multiple types of receivers to receive a signal 24 from a cell 26. In some embodiments, the method further comprises performing one or more measurements M-1 . . . M-N on the signal 24. In some embodiments, the method further comprises, based on one or more respective results of the one or more measurements M-1 . . . M-N and based on whether or not the WUR 12W was used to receive the signal 24, evaluating a criterion C for selecting or reselecting on which cell 26 to camp. In some embodiments, the criterion C is fulfilled when, for each of the one or more measurements M-1 . . . M-N, a condition on a cell (re)selection measurement value calculated from a result of the measurement is met, and evaluating the criterion C comprises, for each of the one or more measurements M-1 . . . M-N, calculating the respective cell (re)selection measurement value based on whether or not the WUR 12W was used to receive the signal 24.

In some embodiments, for each of the one or more measurements M-1 . . . M-N, calculating the respective cell (re)selection measurement value comprises calculating the respective cell (re)selection measurement value as a function of the result of the measurement and a WUR-dependent parameter whose value depends on whether or not the WUR 12W was used to receive the signal 24. In some embodiments, the method further comprises computing the value of the WUR-dependent parameter based on which each respective cell (re)selection measurement value is calculated, as a function of the calculated difference, as scaled and/or biased. In some embodiments, the method further comprises selecting or reselecting on which cell 26 to camp based on said evaluating of the criterion C.

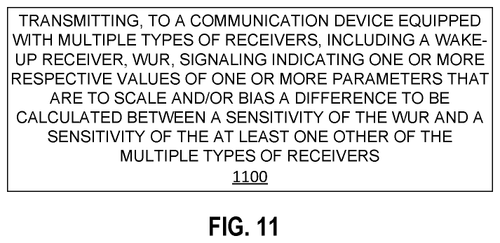

FIG. 11 depicts a method performed by a network node 14 in accordance with other particular embodiments. The method includes transmitting, to a communication device 12 equipped with multiple types of receivers, 12R, 12W including a wake-up receiver, WUR, 12W signaling indicating one or more respective values of one or more parameters that are to scale and/or bias a difference to be calculated between a sensitivity of the WUR 12W and a sensitivity of the at least one other of the multiple types of receivers 12R (Block 1100).

Embodiments herein also include corresponding apparatuses. Embodiments herein for instance include a communication device 12 configured to perform any of the steps of any of the embodiments described above for the communication device 12.

Embodiments also include a communication device 12 comprising processing circuitry and power supply circuitry. The processing circuitry is configured to perform any of the steps of any of the embodiments described above for the communication device 12. The power supply circuitry is configured to supply power to the communication device 12.

Embodiments further include a communication device 12 comprising processing circuitry. The processing circuitry is configured to perform any of the steps of any of the embodiments described above for the communication device 12. In some embodiments, the communication device 12 further comprises communication circuitry.

Embodiments further include a communication device 12 comprising processing circuitry and memory. The memory contains instructions executable by the processing circuitry whereby the communication device 12 is configured to perform any of the steps of any of the embodiments described above for the communication device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the communication device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 14 configured to perform any of the steps of any of the embodiments described above for the network node 14.

Embodiments also include a network node 14 comprising processing circuitry and power supply circuitry. The processing circuitry is configured to perform any of the steps of any of the embodiments described above for the network node 14. The power supply circuitry is configured to supply power to the network node 14.

Embodiments further include a network node 14 comprising processing circuitry. The processing circuitry is configured to perform any of the steps of any of the embodiments described above for the network node 14. In some embodiments, the network node 14 further comprises communication circuitry.

Embodiments further include a network node 14 comprising processing circuitry and memory. The memory contains instructions executable by the processing circuitry whereby the n network node 14 is configured to perform any of the steps of any of the embodiments described above for the network node 14.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

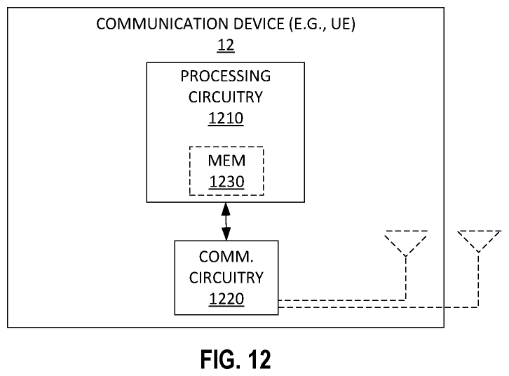

FIG. 12 for example illustrates a communication device 12 as implemented in accordance with one or more embodiments. As shown, the communication device 12 includes processing circuitry 1210 and communication circuitry 1220. The communication circuitry 1220 (e.g., radio circuitry) is configured to transmit and/or receive information to and/or from one or more other nodes, e.g., via any communication technology. Such communication may occur via one or more antennas that are either internal or external to the communication device 12. The processing circuitry 1210 is configured to perform processing described above, e.g., in FIGS. 8, 9, and/or 10, such as by executing instructions stored in memory 1230. The processing circuitry 1210 in this regard may implement certain functional means, units, or modules.

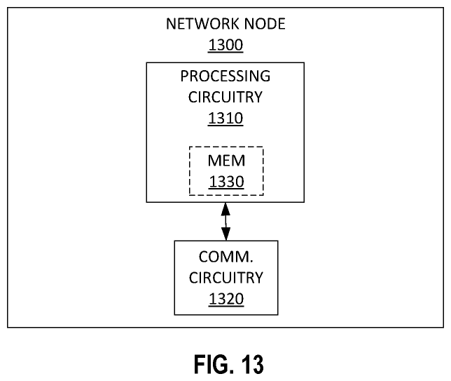

FIG. 13 illustrates a network node 14 as implemented in accordance with one or more embodiments. As shown, the network node 14 includes processing circuitry 1310 and communication circuitry 1320. The communication circuitry 1320 is configured to transmit and/or receive information to and/or from one or more other nodes, e.g., via any communication technology. The processing circuitry 1310 is configured to perform processing described above, e.g., in FIG. 11, such as by executing instructions stored in memory 1330. The processing circuitry 1310 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

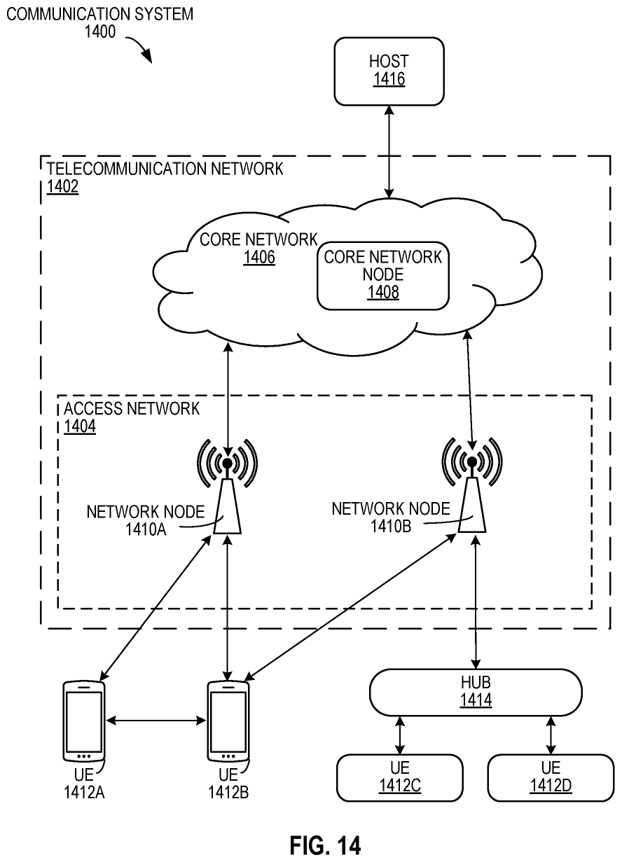

FIG. 14 shows an example of a communication system 1400 in accordance with some embodiments.

In the example, the communication system 1400 includes a telecommunication network 1402 that includes an access network 1404, such as a radio access network (RAN), and a core network 1406, which includes one or more core network nodes 1408. The access network 1404 includes one or more access network nodes, such as network nodes 1410a and 1410b (one or more of which may be generally referred to as network nodes 1410), or any other similar 3rd Generation Partnership Project (3GPP) access node or non-3GPP access point. The network nodes 1410 facilitate direct or indirect connection of user equipment (UE), such as by connecting UEs 1412a, 1412b, 1412c, and 1412d (one or more of which may be generally referred to as UEs 1412) to the core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may include any number of wired or wireless networks, network nodes, UEs, and/or any other components or systems that may facilitate or participate in the communication of data and/or signals whether via wired or wireless connections. The communication system 1400 may include and/or interface with any type of communication, telecommunication, data, cellular, radio network, and/or other similar type of system.

The UEs 1412 may be any of a wide variety of communication devices, including wireless devices arranged, configured, and/or operable to communicate wirelessly with the network nodes 1410 and other communication devices. Similarly, the network nodes 1410 are arranged, capable, configured, and/or operable to communicate directly or indirectly with the UEs 1412 and/or with other network nodes or equipment in the telecommunication network 1402 to enable and/or provide network access, such as wireless network access, and/or to perform other functions, such as administration in the telecommunication network 1402.

In the depicted example, the core network 1406 connects the network nodes 1410 to one or more hosts, such as host 1416. These connections may be direct or indirect via one or more intermediary networks or devices. In other examples, network nodes may be directly coupled to hosts. The core network 1406 includes one more core network nodes (e.g., core network node 1408) that are structured with hardware and software components. Features of these components may be substantially similar to those described with respect to the UEs, network nodes, and/or hosts, such that the descriptions thereof are generally applicable to the corresponding components of the core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1416 may be under the ownership or control of a service provider other than an operator or provider of the access network 1404 and/or the telecommunication network 1402, and may be operated by the service provider or on behalf of the service provider. The host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1400 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1402 is a cellular network that implements 3GPP standardized features. Accordingly, the telecommunications network 1402 may support network slicing to provide different logical networks to different devices that are connected to the telecommunication network 1402. For example, the telecommunications network 1402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1412 are configured to transmit and/or receive information without direct human interaction. For instance, a UE may be designed to transmit information to the access network 1404 on a predetermined schedule, when triggered by an internal or external event, or in response to requests from the access network 1404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1414 communicates with the access network 1404 to facilitate indirect communication between one or more UEs (e.g., UE 1412c and/or 1412d) and network nodes (e.g., network node 1410b). In some examples, the hub 1414 may be a controller, router, content source and analytics, or any of the other communication devices described herein regarding UEs. For example, the hub 1414 may be a broadband router enabling access to the core network 1406 for the UEs. As another example, the hub 1414 may be a controller that sends commands or instructions to one or more actuators in the UEs. Commands or instructions may be received from the UEs, network nodes 1410, or by executable code, script, process, or other instructions in the hub 1414. As another example, the hub 1414 may be a data collector that acts as temporary storage for UE data and, in some embodiments, may perform analysis or other processing of the data. As another example, the hub 1414 may be a content source. For example, for a UE that is a VR headset, display, loudspeaker or other media delivery device, the hub 1414 may retrieve VR assets, video, audio, or other media or data related to sensory information via a network node, which the hub 1414 then provides to the UE either directly, after performing local processing, and/or after adding additional local content. In still another example, the hub 1414 acts as a proxy server or orchestrator for the UEs, in particular in if one or more of the UEs are low energy IoT devices.

The hub 1414 may have a constant/persistent or intermittent connection to the network node 1410b. The hub 1414 may also allow for a different communication scheme and/or schedule between the hub 1414 and UEs (e.g., UE 1412c and/or 1412d), and between the hub 1414 and the core network 1406. In other examples, the hub 1414 is connected to the core network 1406 and/or one or more UEs via a wired connection. Moreover, the hub 1414 may be configured to connect to an M2M service provider over the access network 1404 and/or to another UE over a direct connection. In some scenarios, UEs may establish a wireless connection with the network nodes 1410 while still connected via the hub 1414 via a wired or wireless connection. In some embodiments, the hub 1414 may be a dedicated hub—that is, a hub whose primary function is to route communications to/from the UEs from/to the network node 1410b. In other embodiments, the hub 1414 may be a non-dedicated hub—that is, a device which is capable of operating to route communications between the UEs and network node 1410b, but which is additionally capable of operating as a communication start and/or end point for certain data channels.

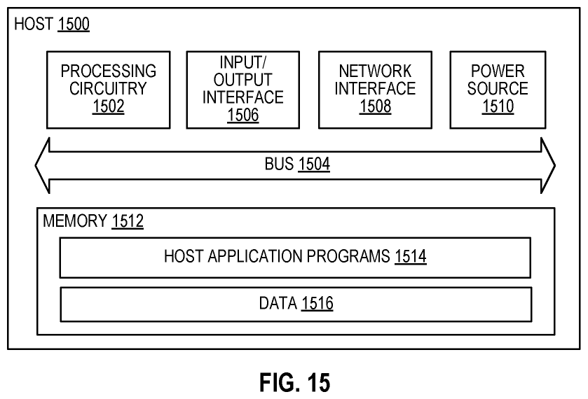

FIG. 15 is a block diagram of a host 1500, which may be an embodiment of the host 1416 of FIG. 14, in accordance with various aspects described herein. As used herein, the host 1500 may be or comprise various combinations hardware and/or software, including a standalone server, a blade server, a cloud-implemented server, a distributed server, a virtual machine, container, or processing resources in a server farm. The host 1500 may provide one or more services to one or more UEs.

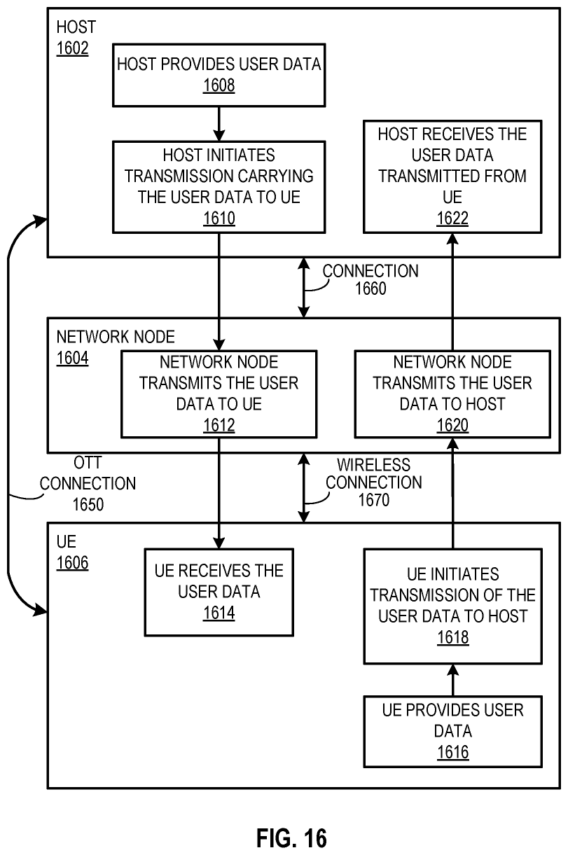

The host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 15 and 16, such that the descriptions thereof are generally applicable to the corresponding components of host 1500.

The memory 1512 may include one or more computer programs including one or more host application programs 1514 and data 1516, which may include user data, e.g., data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 shows a communication diagram of a host 1602 communicating via a network node 1604 with a UE 1606 over a partially wireless connection in accordance with some embodiments. Example implementations, in accordance with various embodiments, of the UE (such as a UE 1412a of FIG. 14 and/or UE 1500 of FIG. 15), network node (such as network node 1410a of FIG. 14 and/or network node 1600 of FIG. 16), and host (such as host 1416 of FIG. 14 and/or host 1500 of FIG. 15) discussed in the preceding paragraphs will now be described with reference to FIG. 16.

Like host 1500, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1406 of FIG. 14) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Some embodiments herein may be generally enumerated as below:

### Group A Embodiments

A1. A method performed by a communication device equipped with multiple types of receivers, including a wake-up receiver, WUR, the method comprising:
using at least one of the multiple types of receivers to receive a signal from a cell; performing one or more measurements on the signal; and
based on one or more respective results of the one or more measurements and based on whether or not the WUR was used to receive the signal, evaluating a criterion for selecting or reselecting on which cell to camp or for ranking cells in terms of how suitable the cells are for camping on.

A2. The method of embodiment A1, wherein the criterion is for selecting or reselecting on which cell to camp.

A3. The method of embodiment A2, wherein the criterion is fulfilled when, for each of the one or more measurements, a condition on a cell (re)selection measurement value calculated from a result of the measurement is met, and wherein evaluating the criterion comprises, for each of the one or more measurements, calculating the respective cell (re)selection measurement value based on whether or not the WUR was used to receive the signal.

A4. The method of embodiment A3, wherein, for each of the one or more measurements, calculating the respective cell (re)selection measurement value comprises calculating the respective cell (re)selection measurement value as a function of the result of the measurement and a WUR-dependent parameter whose value depends on whether or not the WUR was used to receive the signal.

A5. The method of embodiment A4, wherein, for each of the one or more measurements, the WUR-dependent parameter based on which the respective cell (re)selection measurement value is calculated is:
a minimum required level of the result of the measurement in the cell; or
an offset to a minimum required level of the result of the measurement in the cell.

A6. The method of embodiment A4, wherein, for each of the one or more measurements, the WUR-dependent parameter based on which the respective cell (re)selection measurement value is calculated is an offset to the result of the measurement in the cell.

A7. The method of any of embodiments A4-A6, wherein, when the wake-up receiver is used to receive the signal, a value of the WUR-dependent parameter based on which each respective cell (re)selection measurement value is calculated is a function of a difference between a sensitivity of the wake-up receiver and a sensitivity of at least one other of the multiple types of receivers.

A8. The method of any of embodiments A4-A7, further comprising computing the value of the WUR-dependent parameter based on which each respective cell (re)selection measurement value is calculated, as a function of a difference between a sensitivity of the wake-up receiver and a sensitivity of at least one other of the multiple types of receivers.

A9. The method of embodiment A8, wherein said computing comprises computing the value of the WUR-dependent parameter based on which each respective cell (re)selection measurement value is calculated also as a function of one or more parameters that scale and/or bias the difference between the sensitivity of the wake-up receiver and the sensitivity of the at least one other of the multiple types of receivers, and wherein the method further comprises receiving, from a network node, signaling indicating one or more respective values of the one or more parameters.

A10. The method of any of embodiments A8-A9, wherein the sensitivity of the wake-up receiver is specific to the communication device and/or the sensitivity of at least one other of the multiple types of receivers is specific to the communication device and/or is specific to a type of the communication device.

A11. The method of any of embodiments A4-A9, wherein, for each of the one or more measurements, the WUR-dependent parameter based on which the respective cell (re)selection measurement value is calculated is specific to the communication device and/or is specific to a type of the communication device.

A12. The method of any of embodiments A4-A11, wherein the criterion is a criterion for selecting the cell as the cell to camp on, wherein the one or more measurements include a reference signal received power, RSRP, measurement and/or a reference signal received quality, RSRQ, measurement, wherein:
for the RSRP measurement, the WUR-dependent parameter is an offset Q_{rxlevminoffset}^{WUR} comprising an offset to a minimum required RSRP level Qᵣₓₗₑᵥₘᵢₙ in the cell if the wake-up receiver is used to receive the signal; and/or
for the RSRW measurement, the WUR-dependent parameter is an offset Q_{qualminoffset}^{WUR} comprising an offset to a minimum required RSRQ level Q_{qualmin} in the cell if the wake-up receiver is used to receive the signal.

A13. The method of any of embodiments A4-A11, wherein the criterion is a criterion for selecting the cell as the cell to camp on, wherein the one or more measurements include a reference signal received power, RSRP, measurement and/or a reference signal received quality, RSRQ, measurement, wherein:
for the RSRP measurement, the WUR-dependent parameter is a minimum required RSRP level Qᵣₓₗₑᵥₘᵢₙ^{WUR} in the cell if the wake-up receiver is used to receive the signal; and/or
for the RSRQ measurement, the WUR-dependent parameter is a minimum required RSRQ level Q_{qualmin}^{WUR} in the cell if the wake-up receiver is used to receive the signal.

A14. The method of any of embodiments A4-A13, wherein the criterion is a criterion for selecting the cell as the cell to camp on, wherein, for each of the one or more measurements, the condition on the cell (re)selection measurement value calculated from the result of the measurement is met when the cell (re)selection measurement value is greater than zero.

A15. The method of embodiment A2, wherein evaluating the criterion comprises, for each of the one or more measurements:
calculating a cell (re)selection measurement value from a result of the measurement; and
evaluating whether or not a condition on the cell (re)selection measurement value is met, wherein the condition depends on whether or not the WUR was used to receive the signal;
   wherein the criterion is fulfilled when the condition is met for each of the one or more measurements.

A16. The method of embodiment A15, wherein, for each of the one or more measurements, the condition on the cell (re)selection measurement value calculated from the result of the measurement is met when the cell (re)selection measurement value is greater than a WUR-dependent threshold, wherein the value of the WUR-dependent threshold depends on whether or not the WUR was used to receive the signal.

A17. The method of embodiment A16, wherein, for each of the one or more measurements, the value of the respective WUR-dependent threshold is a function of a difference between a sensitivity of the wake-up receiver and a sensitivity of at least one other of the multiple types of receivers.

A18. The method of any of embodiments A16-A17, wherein the criterion is for reselecting on which cell to camp, wherein the cell is a serving cell of the communication device, wherein, when the criterion is fulfilled, the communication device is to reselect on which cell to camp, wherein the one or more measurements include a reference signal received power, RSRP, measurement and/or a reference signal received quality, RSRQ, measurement, wherein:
for the RSRP measurement, the WUR-dependent threshold is a threshold S_{IntraSearchP}; and/or
for the RSRQ measurement, the WUR-dependent threshold is a threshold S_{IntraSearchQ}.

A19. The method of embodiment A2, wherein the criterion evaluated depends on whether or not the WUR was used to receive the signal.

A20. The method of any of embodiments A2-A19, wherein the criterion is for reselecting on which cell to camp, wherein the cell is a serving cell of the communication device, and wherein, when the criterion is fulfilled, the communication device is to reselect on which cell to camp.

A21. The method of embodiment A20, wherein the criterion is the serving cell fulfilling Srxlev>S_{IntraSearchP} and Squal>S_{IntraSearchQ}.

A22. The method of embodiment A1, wherein the criterion is for ranking cells in terms of how suitable the cells are for camping on.

A23. The method of embodiment A22, wherein evaluating the criterion comprises calculating the criterion as a function of whether or not the WUR was used to receive the signal.

A24. The method of embodiment A23, wherein calculating the criterion comprises calculating the criterion as a function of a WUR-dependent parameter whose value depends on whether or not the WUR was used to receive the signal.

A25. The method of embodiment A24, wherein the WUR-dependent parameter is an offset to the result of the measurement in the cell.

A26. The method of any of embodiments A24-A25, wherein a value of the WUR-dependent parameter is a function of a difference between a sensitivity of the wake-up receiver and a sensitivity of at least one other of the multiple types of receivers.

A27. The method of any of embodiments A22-A26, wherein:
the cell is a serving cell of the communication device and the criterion is a cell ranking criterion Rₛ for the serving cell; or
the cell is a neighbor cell of the communication device and the criterion is a cell ranking criterion Rₙ for the neighbor cell.

A28. The method of any of embodiments A1-A27, wherein the one or more measurements include a reference signal received power, RSRP, measurement and a reference signal received quality, RSRQ, measurement.

A29. The method of any of embodiments A1-A27, wherein the one or more measurements comprise a single measurement, wherein the single measurement is a reference signal received power, RSRP, measurement.

A30. The method of any of embodiments A1-A29, wherein the cell is a serving cell of the communication device or a neighbor cell that neighbors a serving cell of the communication device.

A31. The method of any of embodiments A1-A30, wherein the criterion is for selecting or reselecting on which cell to camp, and wherein the method further comprises selecting or reselecting on which cell to camp based on said evaluating of the criterion.

A32. The method of any of embodiments A1-A30, wherein the criterion is for ranking cells in terms of how suitable the cells are for camping on, and wherein the method further comprises:
ranking the cells in terms of how suitable the cells are for camping on based on said evaluating; and
selecting which cell to camp on according to the ranking of the cells.

AA1. A method performed by a communication device equipped with multiple types of receivers, including a wake-up receiver, WUR, the method comprising:
receiving, from a network node, signaling indicating one or more respective values of one or more parameters that are to scale and/or bias a difference to be calculated between a sensitivity of the WUR and a sensitivity of the at least one other of the multiple types of receivers.

AA2. The method of embodiment AA1, further comprising:
calculating the difference between the sensitivity of the WUR and the sensitivity of the at least one other of the multiple types of receivers; and
scaling and/or biasing the calculated difference using the one or more respective values of the one or more parameters indicated by the received signaling.

AA3. The method of any of embodiments AA1-AA2, further comprising
using at least one of the multiple types of receivers to receive a signal from a cell; performing one or more measurements on the signal;
based on one or more respective results of the one or more measurements and based on whether or not the WUR was used to receive the signal, evaluating a criterion for selecting or reselecting on which cell to camp, wherein the criterion is fulfilled when, for each of the one or more measurements, a condition on a cell (re)selection measurement value calculated from a result of the measurement is met, and wherein evaluating the criterion comprises, for each of the one or more measurements, calculating the respective cell (re)selection measurement value based on whether or not the WUR was used to receive the signal, wherein, for each of the one or more measurements, calculating the respective cell (re)selection measurement value comprises calculating the respective cell (re)selection measurement value as a function of the result of the measurement and a WUR-dependent parameter whose value depends on whether or not the WUR was used to receive the signal;
computing the value of the WUR-dependent parameter based on which each respective cell (re)selection measurement value is calculated, as a function of the calculated difference, as scaled and/or biased.

AA4. The method of embodiment AA3, further comprising selecting or reselecting on which cell to camp based on said evaluating of the criterion.

AA. The method of any of the previous embodiments, further comprising:
providing user data; and
forwarding the user data to a host computer via the transmission to a base station.

### Group B Embodiments

B1. A method performed by a network node, the method comprising:
transmitting, to a communication device equipped with multiple types of receivers, including a wake-up receiver, WUR, signaling indicating one or more respective values of one or more parameters that are to scale and/or bias a difference to be calculated between a sensitivity of the WUR and a sensitivity of the at least one other of the multiple types of receivers.

BB. The method of any of the previous embodiments, further comprising:
obtaining user data; and
forwarding the user data to a host computer or a communication device.

### Group C Embodiments

C1. A communication device configured to perform the method of any of the Group A embodiments.

C2. A communication device comprising processing circuitry configured to perform the method of any of the Group A embodiments.

C3. A communication device comprising:
communication circuitry; and
processing circuitry configured to perform the method of any of the Group A embodiments.

C4. A communication device comprising:
processing circuitry configured to perform the method of any of the Group A embodiments; and
power supply circuitry configured to supply power to the communication device.

C5. A communication device comprising:
processing circuitry and memory, the memory containing instructions executable by the processing circuitry whereby the communication device is configured to perform the method of any of the Group A embodiments.

C6. The communication device of any of embodiments C1-C5, wherein the communication device is a wireless communication device.

C7. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform the method of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

C8. A computer program comprising instructions which, when executed by at least one processor of a communication device, causes the communication device to perform the method of any of the Group A embodiments.

C9. A carrier containing the computer program of embodiment C7, wherein the carrier is one of an electronic signal, optical signal, radio signal, or computer readable storage medium.

C10. A network node configured to perform the method of any of the Group B embodiments.

C11. A network node comprising processing circuitry configured to perform the method of any of the Group B embodiments.

C12. A network node comprising:
communication circuitry; and
processing circuitry configured to perform the method of any of the Group B embodiments.

C13. A network node comprising:
processing circuitry configured to perform the method of any of the Group B embodiments;
power supply circuitry configured to supply power to the network node.

C14. A network node comprising:
processing circuitry and memory, the memory containing instructions executable by the processing circuitry whereby the network node is configured to perform the method of any of the Group B embodiments.

C15. The network node of any of embodiments C10-C14, wherein the network node is a base station.

C16. A computer program comprising instructions which, when executed by at least one processor of a network node, causes the network node to perform the method of any of the Group B embodiments.

C17. The computer program of embodiment C16, wherein the network node is a base station.

C18. A carrier containing the computer program of any of embodiments C16-C17, wherein the carrier is one of an electronic signal, optical signal, radio signal, or computer readable storage medium.

### Group D Embodiments

D1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform the method of any of the Group B embodiments to transmit the user data from the host to the UE.

D2. The host of the previous embodiment, wherein:
the processing circuitry of the host is configured to execute a host application that provides the user data; and
the UE comprises processing circuitry configured to execute a client application associated with the host application to receive the transmission of user data from the host.

D3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the method of any of the Group B embodiments to transmit the user data from the host to the UE.

D4. The method of the previous embodiment, further comprising, at the network node, transmitting the user data provided by the host for the UE.

D5. The method of any of the previous 2 embodiments, wherein the user data is provided at the host by executing a host application that interacts with a client application executing on the UE, the client application being associated with the host application.

D6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform the method of any of the Group B embodiments to transmit the user data from the host to the UE.

D7. The communication system of the previous embodiment, further comprising:
the network node; and/or
the user equipment.

D8. The communication system of the previous 2 embodiments, wherein:
the processing circuitry of the host is configured to execute a host application, thereby providing the user data; and
the host application is configured to interact with a client application executing on the UE, the client application being associated with the host application.

D9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform method of any of the Group B embodiments to receive the user data from the UE for the host.

D10. The host of the previous 2 embodiments, wherein:
the processing circuitry of the host is configured to execute a host application, thereby providing the user data; and
the host application is configured to interact with a client application executing on the UE, the client application being associated with the host application.

D11. The host of the any of the previous 2 embodiments, wherein the initiating receipt of the user data comprises requesting the user data.

D12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the method of any of the Group B embodiments to receive the user data from the UE for the host.

D13. The method of the previous embodiment, further comprising at the network node, transmitting the received user data to the host.

D14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform the method of any of the Group A embodiments to receive the user data from the host.

D15. The host of the previous embodiment, wherein the cellular network further includes a network node configured to communicate with the UE to transmit the user data to the UE from the host.

D16. The host of the previous 2 embodiments, wherein:
the processing circuitry of the host is configured to execute a host application, thereby providing the user data; and
the host application is configured to interact with a client application executing on the UE, the client application being associated with the host application.

D17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs the method of any of the Group A embodiments to receive the user data from the host.

D18. The method of the previous embodiment, further comprising:
at the host, executing a host application associated with a client application executing on the UE to receive the user data from the UE.

D19. The method of the previous embodiment, further comprising:
at the host, transmitting input data to the client application executing on the UE, the input data being provided by executing the host application,
wherein the user data is provided by the client application in response to the input data from the host application.

D20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform the method of any of the Group A embodiments to transmit the user data to the host.

D21. The host of the previous embodiment, wherein the cellular network further includes a network node configured to communicate with the UE to transmit the user data from the UE to the host.

D22. The host of the previous 2 embodiments, wherein:
the processing circuitry of the host is configured to execute a host application, thereby providing the user data; and
the host application is configured to interact with a client application executing on the UE, the client application being associated with the host application.

D23. A method implemented by a host configured to operate in a communication system that further includes a network node and a user equipment (UE), the method comprising:
at the host, receiving user data transmitted to the host via the network node by the UE, wherein the UE performs the method of any of the Group A embodiments to transmit the user data to the host.

D24. The method of the previous embodiment, further comprising:
at the host, executing a host application associated with a client application executing on the UE to receive the user data from the UE.

D25. The method of the previous embodiments, further comprising:
at the host, transmitting input data to the client application executing on the UE, the input data being provided by executing the host application,
wherein the user data is provided by the client application in response to the input data from the host application.

### REFERENCES

1. RP-213645, “New SID: Study on low-power Wake-up Signal and Receiver for NR”, RAN plenary #94, December 2021.
2. RP-222644, “Revised SID on low-power WUS WUR for NR”, RAN plenary #97e, September 2022.
3. TS 38.331, “NR; Radio Resource Control (RRC); Protocol specification”
4. TS 38.304, “NR; User Equipment (UE) procedures in idle mode and in RRC Inactive state”

1.-24. (canceled)

25. A method performed by a communication device, the method comprising:
performing one or more measurements on a signal from a cell; and
based on one or more respective results of the one or more measurements, evaluating a criterion for selecting or reselecting on which cell to camp or for ranking cells in terms of how suitable the cells are for camping on, wherein the criterion depends on whether or not a wake-up receiver (WUR) is used to perform the one or more measurements.

26. The method of claim 25, wherein the criterion is for selecting or reselecting on which cell to camp, wherein the criterion is fulfilled when, for each of the one or more measurements, a condition on a cell selection or reselection measurement value calculated from a result of the measurement is met, wherein, for each of the one or more measurements, the respective cell selection or reselection measurement value depends on whether or not the WUR is used to perform the measurement.

27. The method of claim 26, wherein, for each of the one or more measurements, the respective cell selection or reselection measurement value is a function of the result of the measurement and a WUR-dependent parameter whose value depends on whether or not the WUR is used to perform the measurement.

28. The method of claim 27, wherein, for each of the one or more measurements, the WUR-dependent parameter of which the respective cell selection or reselection measurement value is a function is:
a minimum required level of the result of the measurement in the cell; or
an offset to a minimum required level of the result of the measurement in the cell; or
an offset to the result of the measurement in the cell.

29. The method of claim 27, wherein, for each of the one or more measurements, the WUR-dependent parameter of which the respective cell selection or reselection measurement value is a function is specific to a type of the communication device or a type of WUR used to perform the measurement.

30. The method of claim 27, wherein the criterion is a criterion for selecting the cell as the cell to camp on, wherein the one or more measurements include a reference signal received power (RSRP) measurement and/or a reference signal received quality (RSRQ) measurement, wherein:
for the RSRP measurement, the WUR-dependent parameter is an offset Q_{rxlevminoffset}^{WUR} comprising an offset to a minimum required RSRP level Qᵣₓₗₑᵥₘᵢₙ in the cell if the WUR is used to perform the RSRP measurement; and/or
for the RSRQ measurement, the WUR-dependent parameter is an offset Q_{qualminoffset}^{WUR} comprising an offset to a minimum required RSRQ level Q_{qualmin} in the cell if the WUR is used to perform the RSRQ measurement.

31. The method of claim 27, wherein the criterion is a criterion for selecting the cell as the cell to camp on, wherein the one or more measurements include a (RSRP measurement and/or a RSRQ measurement, wherein:
for the RSRP measurement, the WUR-dependent parameter is a minimum required RSRP level Qᵣₓₗₑᵥₘᵢₙ^{WUR} in the cell if the WUR is used to perform the RSRP measurement; and/or
for the RSRQ measurement, the WUR-dependent parameter is a minimum required RSRQ level Q_{qualmin}^{WUR} in the cell if the WUR is used to perform the RSRQ measurement.

32. The method of claim 27, further comprising receiving signaling indicating one or more respective values of one or more parameters, wherein a value of the WUR-dependent parameter is based on said one or more parameters.

33. The method of claim 32, wherein said value of the WUR-dependent parameter is a function of:
a difference between a sensitivity of the WUR and a sensitivity of at least one other type of receiver; and
said one or more parameters,
wherein, in said function, said one or more parameters scale and/or bias the difference between the sensitivity of the wake-up receiver and the sensitivity of the at least one other type of receiver.

34. The method of claim 25, wherein the criterion is for selecting or reselecting on which cell to camp, wherein the criterion is fulfilled when, for each of the one or more measurements, a condition on a cell selection or reselection measurement value calculated from a result of the measurement is met, wherein the condition depends on whether or not the WUR is used to perform the measurement.

35. The method of claim 34, wherein, for each of the one or more measurements, the condition on the cell selection or reselection measurement value calculated from the result of the measurement is met when the cell selection or reselection measurement value is greater than a WUR-dependent threshold, wherein the value of the WUR-dependent threshold depends on whether or not the WUR is used to perform the measurement.

36. The method of claim 35, wherein the criterion is for reselecting on which cell to camp, wherein the cell is a serving cell of the communication device, wherein, when the criterion is fulfilled, the communication device is to reselect on which cell to camp, wherein the one or more measurements include a reference signal received power, RSRP, measurement and/or a reference signal received quality, RSRQ, measurement, wherein:
for the RSRP measurement, the WUR-dependent threshold is a threshold S_{IntraSearchP};
and/or for the RSRQ measurement, the WUR-dependent threshold is a threshold S_{IntraSearchQ}.

37. The method of claim 25, wherein the one or more measurements include a reference signal received power (RSRP) measurement and a reference signal received quality (RSRQ) measurement.

38. The method of claim 25, wherein the criterion is for selecting or reselecting on which cell to camp, and wherein the method further comprises selecting or reselecting on which cell to camp based on said evaluating of the criterion.

39. The method of claim 25, wherein the criterion is for ranking cells in terms of how suitable the cells are for camping on, wherein the one or more measurements comprise a reference signal received power (RSRP) measurement, wherein the criterion is a function of a WUR-dependent parameter whose value depends on whether or not the WUR is used to perform the RSRP measurement.

40. The method of claim 39, wherein the WUR-dependent parameter is an offset to the result of the RSRP measurement.

41. The method of claim 25, wherein the criterion is for ranking cells in terms of how suitable the cells are for camping on, and wherein the method further comprises:
ranking the cells in terms of how suitable the cells are for camping on based on said evaluating; and
selecting which cell to camp on according to the ranking of the cells.

42. The method of claim 25, wherein the communication device is equipped with multiple types of receivers, including a WUR.

43. A communication device comprising:
communication circuitry; and
processing circuitry configured to:
perform one or more measurements on a signal from a cell; and
based on one or more respective results of the one or more measurements, evaluate a criterion for selecting or reselecting on which cell to camp or for ranking cells in terms of how suitable the cells are for camping on, wherein the criterion depends on whether or not a wake-up receiver, WUR, is used to perform the one or more measurements.
